(19) United States
(12) Patent Application Publication
(10) Pub. No.: US 2006/0074702 A1
(43) Pub. Date: Apr. 6, 2006

(54) Method and system for managing a fleet of vehicles

(76) Inventors: Thomas A. Schuette, St. Charles, MO (US); Rebecca Alkhas, Webster Groves, MO (US); Jeffrey Lee Everson, Ballwin, MO (US); John Dwight Fehr, Valley Park, MO (US); Kurt Walter Kohler, St. Louis, MO (US); William Sean Ritzie, St. Louis, MO (US); Glenn T. Roxas, Chesterfield, MO (US); David Keith Stamps, Florissant, MO (US); Chee-Koon Toh, Chesterfield, MO (US); Daniel Alan Weas, St. Louis, MO (US); Anthony Keith Woods, Webster Groves, MO (US); Milton Fehr, Valley Park, MO (US)

Correspondence Address: Benjamin L. Volk, Jr.;Thompson Coburn LLP, Suite 3500, One US Bank Plaza, St. Louis, MO, 63101-9928, US

(21) Appl. No.: 10/959,925

(22) Filed: Oct. 6, 2004

(51) Int. Cl. G06Q 99/00

(52) U.S. Cl. 705/1

(57) ABSTRACT

A system for providing a user with historical sales data for a plurality of vehicles comprising a fleet, the system comprising: (a) a database configured to store actual sales data for a plurality of vehicles that have previously been sold; and (b) a computer in communication with the database, the computer being configured to create a page for display to a user, the page including a display of a plurality of historical sales prices for at least one vehicle type that is similar to a user-selected vehicle type, wherein the displayed historical sales prices are calculated from the stored actual sales data and comprise historical sales prices for the at least one similar vehicle type that have been normalized to an average time of sale odometer reading. Also disclosed herein is a computer-implemented method for selecting which of a plurality of vehicles within a fleet are to be deleted from the fleet; the method comprising: (a) displaying, on an electronic page presented to a computer user, a value analysis for at least one type of vehicle within a rental vehicle fleet; (b) providing at least one link on the electronic page for selection by the user to initiate a deletion from the fleet of at least one fleet vehicle corresponding to the at least one vehicle type; and (c) responsive to user selection of the at least one link, displaying a list of fleet vehicles for selectable deletion from the fleet by the user, the listed fleet vehicles corresponding to vehicles of the at least one vehicle type.

### FIELD OF THE INVENTION

The present invention relates to the field of fleet management. In particular, the present invention relates to the management of a plurality of vehicles comprising a fleet so that informed decisions can be made as to the deletion of vehicles from the fleet.

### BACKGROUND OF THE INVENTION

Companies that maintain a fleet comprising numerous vehicles are faced with a daunting challenge with respect to how to effectively track and cost manage the fleet. Among the difficult questions that face fleet managers include which vehicles to delete from the fleet and when to do so. This is a difficult task for companies that maintain a relatively small fleet of vehicles much less for companies (such as the assignee of the present invention) that maintain a large fleet of vehicles.

For example, at any given time, the assignee of the present invention maintains a fleet of approximately 650,000 vehicles (including rental vehicles and leased vehicles), a number that is constantly growing with time. Not only does this fleet population represent a vast number, but it also must be noted that this fleet is divided into numerous geographically separated subfleets, each subfleet having its own characteristics that affect management decisions relating thereto, thereby further complicating the fleet management process. To effectively operate a rental vehicle business, the rental company must effectively plan and cost manage the influx and outflux of rental vehicles from the fleet. On the basis of value depreciation, rental vehicles will need to be timely deleted from the rental fleet and shifted to the used vehicle sales (remarketing) market.

Toward this end, the assignee of the present invention had previously developed and implemented a fleet planning system that allowed users to enter residual values for vehicles in the fleet at the year, make, model, and series (YMMS) level (wherein “series” specifies a particular series, body style, version, etc. of a particular YMM), determine the cost going forward (CGF) for each YMMS based on the user-entered residual value estimations, and designate a total number of vehicles within a particular YMMS that are to be deleted from the fleet. While this system certainly provided value and efficiency to the fleet planning process, room for improvement still existed. For example, this fleet planning system did not provide any historical sales data about fleet YMMSs to users to help guide their residual value estimations. Accordingly, users had only their own business sense to rely upon when estimating a residual value for a fleet YMMS. Further still, users were unable to schedule specific vehicles for deletion from the fleet and were instead provided only the ability to designate a total number of vehicles within a YMMS that were to be deleted.

Additionally, the assignee of the present invention also previously developed and implemented a fleet data warehouse application that allowed users to submit queries to a fleet database and receive (in response to the queries) simplified arithmetic averages of raw data for past vehicle sales. However, with this previous data warehouse application, due to the nature of these simplified raw data averages, users were unable to efficiently compare year-to-year and month-to-month trends in sales price because comparing these different average values was similar to comparing apples to oranges.

### SUMMARY OF THE INVENTION

In an effort to improve upon previous efforts at fleet management, the inventors herein have developed a system that analyzes historical sales data for vehicles that were previously sold as used vehicles, normalizes this historical sales data to a particular value for a parameter common to the historical sales, and presents the results derived from this normalization to users. By providing users with detailed historical sales data drawn from previous sales of vehicles, users are now able to take advantage of normalized historical sales data to temper their own business judgments as to how a particular vehicle type's residual value can be accurately estimated, which the inventors believe will enable users to more accurately forecast future residual values. Because residual value estimations are one of the driving forces behind determining how many of a particular vehicle type are to be deleted from a fleet, accuracy in residual value estimation is highly important in the fleet management process.

Preferably, the historical sales data analysis provided by the present invention for a particular vehicle type (such as YMMS) is based on, at least in part, the actual sales prices for previously sold vehicles of the same or similar YMMS and the actual odometer reading for those vehicles at the time of sale. From these data values, a calculation is made as to what the average odometer reading was for those vehicles at their times of sale. Thereafter, each vehicle's sale price is preferably normalized to this average odometer reading such that each vehicle is assigned an adjusted sales price that matches what that vehicle would have been expected to sell for if that vehicle had the average odometer reading on its odometer at the time of sale. In the U.S. and other countries that use miles as the unit of measure for distances traveled by vehicles, it is preferred that the odometer readings be expressed in terms of mileage. For countries that use kilometers as the appropriate unit of measure, it is preferred that the odometer readings be expressed in terms of kilometers. To aid in this normalization process, a table that relates vehicle value to a time of sale odometer reading, referred to herein in a preferred U.S. embodiment as a cost per mile table, is preferably used. These normalized sales prices can then be averaged together to determine, for vehicles within a YMMS that is the same or similar to a user-selected YMMS, an average sales price normalized to an average mileage.

Also, to further provide the user with detailed historical sales data, this average mileage determination and sales price normalization are preferably performed on a per month basis such that the average mileage analysis for a particular month only covers the sales of vehicles within a same or similar YMMS that occurred in that particular month, with the year of sale effectively being disregarded. The sales price normalization and averaging are preferably performed per YMMS per month. Having done so, users can be provided with a data table that identifies for each month of any given year: (1) an average mileage for vehicles within a same or similar YMMS that were sold in that month and (2) an average normalized sales price for vehicles within each YMMS that were sold in that month. This historical data can be generated and displayed going back several years if desired by a practitioner of the present invention. Having historical sales values normalized to average mileages for the same or similar YMMSs sold in specific months allows users to easily compare year-to-year changes in YMMS sales price as well as month-to-month sales trends.

To aid the system in pooling historical sales data for a user-selected YMMS, a mapping program is preferably made available to users that allows users to group a plurality of previous year YMMSs (and possibly current year YMMSs) to a particular current year YMMS. Sales data for these grouped YMMSs will then be analyzed in accordance with the techniques described above to generate the average mileages and the average normalized sales prices. The YMMS group corresponding to a user-selected YMMSs would thus comprise the user-selected YMMS and any other YMMS(s) deemed to be similar to the user-selected YMMS. An example will help illustrate this mapping process. To perform a historical sales analysis for a hypothetical YMMS of a 2004 MKE MDL SER, the system will preferably perform the above-described historical sales analysis for the 2003 MKE MDL SER, the 2002 MKE MDL SER, and so on for previous vehicles that are deemed by the user to be sufficiently similar to the user-selected YMMS. To enable this historical analysis, it is preferred that such older YMMSs (the 2003 and older MKE MDL SERS) be grouped with the current YMMS (the 2004 MKE MDL SER). Once the YMMS are so grouped into a common YMMS group, the software of the present invention will know which sales data stored in the database should be accessed to perform the historical analysis.

The data table described above for normalized historical sales data for each month applicable to a user-selected YMMS is preferably displayed by the system to users via a page on the user's computer monitor. This page preferably also allows the users to enter residual value estimates for that YMMS for the current month and a plurality of future months. Once the user enters these residual value estimates, the system can perform a CGF analysis on the user-entered residual values. This CGF analysis preferably generates and displays a CGF for the user-selected YMMS.

To flag vehicles for deletion, at least partially on the basis of the user's analysis of these CGF values, the system preferably provides the user with the ability to access a list of specific vehicles within a YMMS to which the CGF analysis pertains, each vehicle preferably being listed along with its current mileage, wherein the list allows the user to select specific vehicles for deletion. Upon selection by the user of one or more specific vehicles for deletion from the list, a message can be sent to a branch manager or other person in charge of a selected vehicle that the vehicle can be timely transferred out of the rental fleet and into the used vehicle (remarketing) market. Alternatively, a flag can be added to a vehicle database record that notifies interested persons that the selected vehicle(s) is to be transferred out of the rental fleet and into the used vehicle market.

While the principal advantages and features of the invention have been discussed above, a greater understanding of the invention including a fuller description of its other advantages and features may be attained by referring to the drawings and the detailed description of the preferred embodiment which follow.

### BRIEF DESCRIPTION OF THE DRAWINGS

FIG. 1 depicts a high level overview of the system of the preferred embodiment of the present invention;

FIG. 2 illustrates a preferred block diagram overview of the navigational path for the fleet management application;

FIGS. 3(a)-(c) illustrate respectively, a preferred log-in screen, a preferred change password screen, and a preferred session timeout screen for the fleet management application;

FIG. 4 illustrates a preferred home page for the fleet management application;

FIGS. 5(a) and (b) illustrate, respectively, a preferred unauthorized access screen and a preferred technical difficulties screen;

FIG. 6 illustrates a preferred residuals parameter entry screen;

FIGS. 7(a) and (b) illustrate preferred residual value table screens;

FIG. 7(c) illustrates a preferred printer-friendly residual table report;

FIG. 8 is a flowchart depicting a preferred technique for calculating the monthly average mileages shown in the residual table;

FIG. 9 is a flowchart depicting a preferred technique for calculating the monthly historical sales prices shown in the residual table;

FIG. 10 illustrates a preferred cost going forward parameter entry screen;

FIGS. 11(a)-(c) illustrate preferred CGF analysis results screens;

FIG. 11(d) illustrates a preferred printer-friendly CGF analysis results report;

FIG. 12 is a flowchart depicting a preferred technique for calculating the projected YMMS values in the CGF results table;

FIG. 13 illustrates a preferred activations screen;

FIGS. 14(a) and (b) illustrate preferred tools for mapping YMMSs into YMMS groups; and

FIG. 15 is a flowchart depicting a preferred technique for creating a cost per mile table.

### DETAILED DESCRIPTION OF THE PREFERRED EMBODIMENT

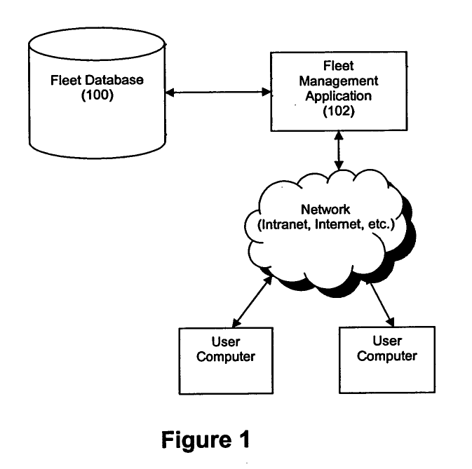

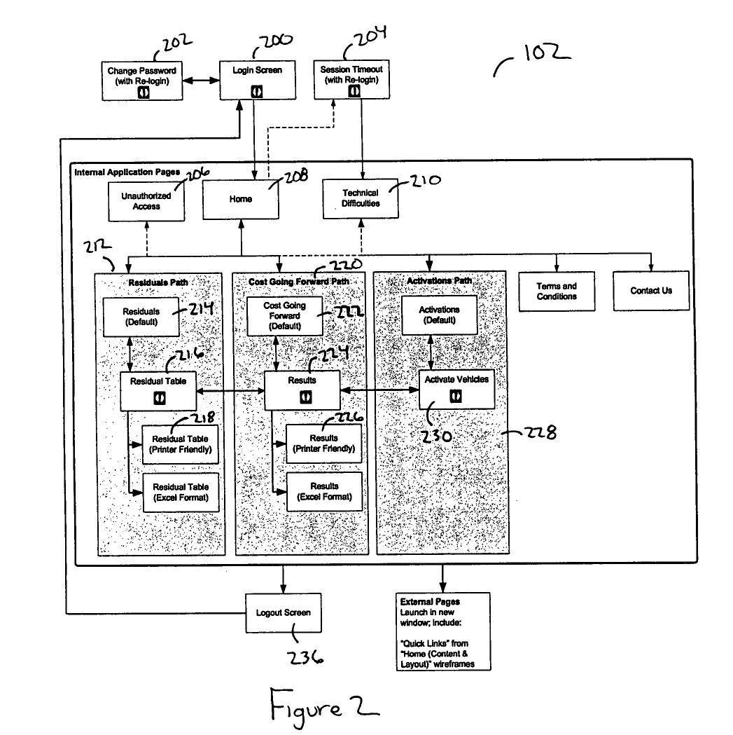

FIG. 1 illustrates a high level overview of the system of the preferred embodiment of the present invention. In the system of FIG. 1, a fleet management application 102 is in communication with a fleet database 100. Fleet database 100 can be in communication with fleet application 102 via any technique for data communication, including but not limited to a direct communication link and a communication link via a network, wherein the network can encompass any type of network over which data is communicated, including but not limited to the Internet, an intranet, a satellite network, a wireless network, a cable network, etc. In its most preferred form, the system described herein is implemented by a rental car company that manages a fleet of rental vehicles. However, it is worth noting that it need not be a rental car company that performs the fleet management and that the vehicles in the fleet being managed need not be rental vehicles. Fleet database 100 stores vehicle data for the vehicles that are currently or were formerly part of the fleet. Fleet database 100 encompasses not only a single database but also a plurality of separate databases (internal and/or external to the entity operating the application 102) accessible by fleet management application 102. The vehicle data stored in database 100 includes historical sales data for vehicles sold from the fleet, including data such as vehicle unit number, vehicle YMMS (year, make, model, and series), sales price, mileage at the time of sale, unit cost, date of initial purchase, depreciation amount, the rental branch to which the vehicle once belonged, who purchased the vehicle, whether the vehicle was a used car, whether the vehicle is a rental vehicle or a leased vehicle, whether the vehicle is a company car, when the vehicle was sold, time in service, vehicle condition, an identification of the previous owner, and other vehicle data types described herein or considered pertinent by a practitioner of the present invention. Further, it is worth noting that this sales date need not be limited to only sales data for fleet vehicles, but can also encompass sales data for external or non-fleet vehicles.

Fleet management application 102 is preferably a software application programmed to allow users to obtain (1) meaningful data about the historical sales prices for rental vehicles in the fleet that previously were sold as used vehicles, thereby enabling more accurate estimation by the user of residual values for rental vehicles in the fleet, and (2) meaningful data about the cost going forward (CGF) for rental vehicles in the fleet, thereby allowing users to make informed decisions about which rental vehicles to remove from the fleet and place into the vehicle sales market. This software can be loaded onto computer readable media such as the hard drive(s) of one or more servers accessible to user computers connected thereto via a network. This network can be any type of network over which data is communicated, including but not limited to the Internet, an intranet, a satellite network, a wireless network, a cable network, etc. For example, the software that is programmed to carry out the fleet management application can be loaded onto one or more servers accessible over a company's intranet for execution on demand by company computers that are connected to that intranet. Further, the one or more servers upon which the application 102 is loaded can be connected to the Internet to provide a wider range of users with access to its features. Further still, it is conceivable that the fleet management software and/or fleet database could be stored on other computer readable media such as a CD-ROM, a PC or laptop hard drive, PDA, any other type of mobile/portable computing technology, or the like.

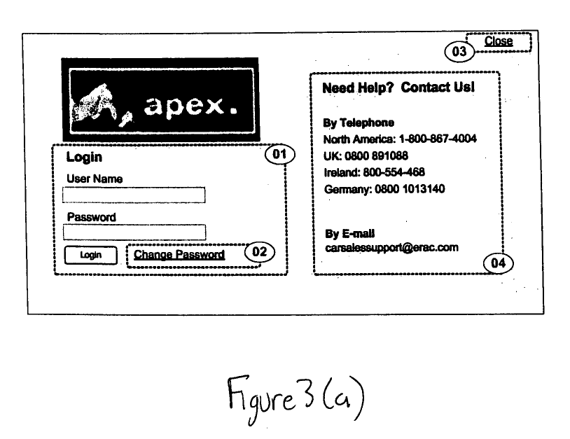

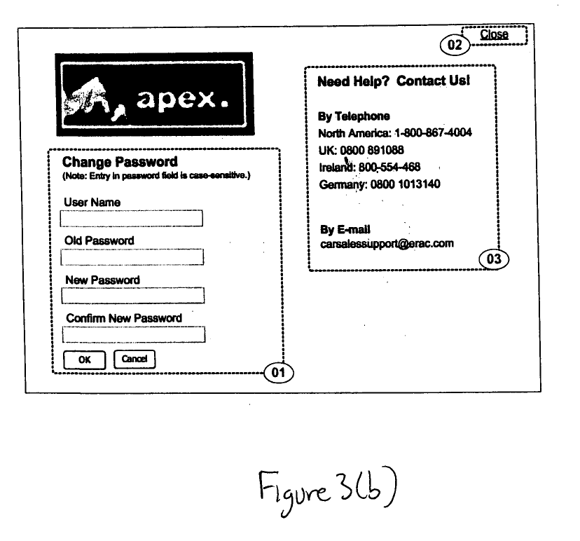

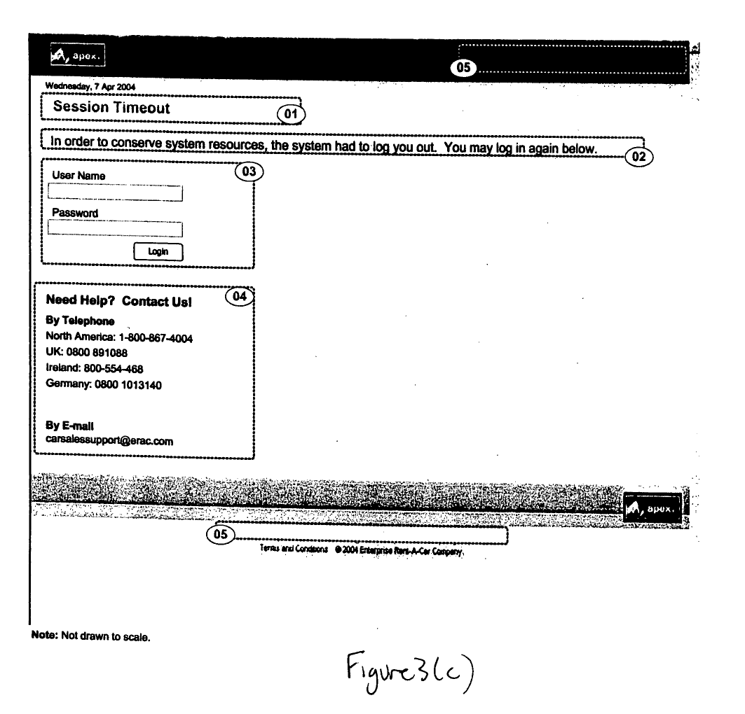

FIG. 2 provides a detailed overview of the interface components comprising the fleet management application 102. Users of the application 102 are required to log in via log in screen 200, depicted in FIG. 3(a). Preferably, access to application 102 is restricted to authorized users, and such users are required provide an ID and password to gain access thereto. Should the user wish to change his/her password, application 102 provides a “change password” screen 202, depicted in FIG. 3(b). If a logged-in user has been inactive with respect to his/her interaction with the application 102 beyond a predetermined amount of time (e.g., one hour), then the user's session times out and a session timeout/re-log in screen (FIG. 3(c)) is presented to the user. However, it should be noted that some practitioners of the present invention may possibly deem the need to restrict users from accessing some or all of its screens unnecessary.

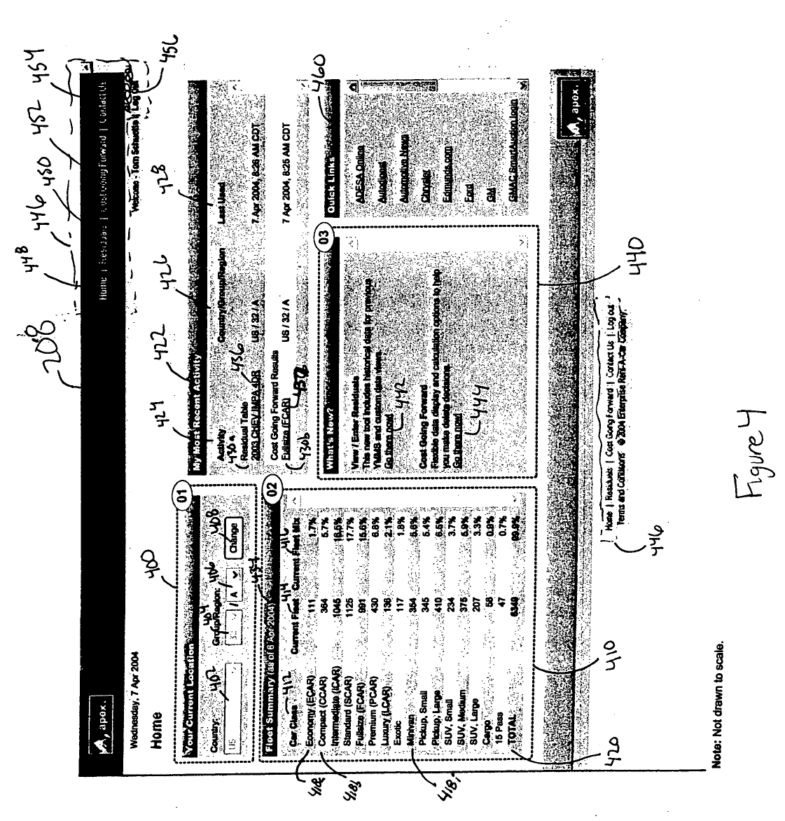

After successfully logging in via screen 200, the user is presented with the fleet management home page 208 depicted in FIG. 4. Home page 208 serves as the central jumping off point for the user that provides the user with access to pages for viewing historical sales values for a particular vehicle type, entering vehicle residual values, and viewing the CGF for existing rental vehicles in the fleet. The fleet management home page 208 preferably includes a current location display section 400, a fleet summary display section 410, a recent activity display section 422, a feature gateway display section 440, one or more navigation bars 446, and a quick links display section 460.

The current location display section 400 allows users to view and/or specify constraint information (preferably geographical constraint information) on the scope of vehicle data to be processed by application 102. Field 402 identifies the high level area from which the vehicle data will be drawn. Field 404 identifies a lower level area from which the vehicle data is drawn, and field 406 identifies a yet lower level area from which the vehicle data will be drawn. In the preferred embodiment, the high level area is a country or continent (e.g., US, Canada, North America, Great Britain, Germany, Europe, etc.), the next lower level area is a country/continent subregion (e.g., southern California, northeast Ohio, mid-Pennsylvania, etc.), and the lowest level area is a subregion within the subregion (e.g., the Los Angeles area within the U.S./southern California region). Numerical codes, alphabetic codes, or alphanumerical codes may be used to represent these different levels. The preferred nomenclature for this breakdown is country/group/region. However, it should be understood that different terminology, different geographical breakdowns, and different numbers of hierarchical levels can be applied to constrain the vehicle data as a matter of design choice by practitioners of the present invention. For example, an intermediate level could be added between the highest level area and the next level area that corresponds to a larger subregion within the specified country/continent (e.g., midwest, west coast, etc.). Further still, more or fewer levels could be put in place, even down to the rental branch location level. Moreover, the criteria for constraining the data need not be broken down by geographical area at all. For example, the vehicle data can be constrained by the business entities that own or operate the vehicles, whether the vehicles are leases or rentals, by vehicle manufacturer, by whether the vehicle is a domestic or import, etc.

Also, in the preferred embodiment, different users will preferably have different levels of access to different country/group/regions depending upon their authorizations within the company. Further, each authorized user will preferably be associated with a default value for country/group/region depending upon his/her level of authorization. Preferably, a fleet manager for the midwest region will only have “delete” access to midwest level (and lower) vehicle data, and his/her default country/group/region setting would be US/Midwest (with no default value being provided by the “region” level). Similarly, a fleet manager for the St. Louis area will preferably only have access to St. Louis area vehicle data, and his/her default country/group/region setting would be US/St. Louis. The default country/group/region setting for a fleet manager for the Miami area would be US/south Florida/Miami. A corporate level fleet manager, however, may be given access to all country/group/regions of the fleet. However, it is worth noting that some practitioners of the present invention may choose to place no authorization restrictions on users.

In a preferred embodiment, the country/group/region technique will be implemented as follows. For country field 402, the value therein will be the user's default value for country. Preferably, only corporate users are allowed to change the view to a different country. As such, for non-corporate users, the country field 402 is display only. For group field 404, the group values are displayed based on the country value in field 402. For all authorized users other than corporate users, the group value will default to the user's associated group value. In such cases, the group field 404 will be display only. Corporate users are preferably allowed to change the view to different group values. For region field 406, the region value is displayed based on the regionalized group value in field 404. Preferably, only corporate users or users authorized to access a group broken down into regions have the ability to change region values. For all other users, region field 406 is preferably display only. User control over any changes to the country/group/region values are implemented via user selection of change button 408.

Fleet summary display section 410 serves as a snapshot for the user of the current fleet status for the country/group/region identified in section 400. This display serves as a valuable tool for providing users with a near real-time view of the current mix of car classes within a fleet. The data displayed in the fleet summary section 410 is derived from the stored vehicle data in database 100 meeting the applicable country/group/region constraints. Beyond the country/group/region constraint, preferable rules for determining which vehicles in the database 100 should be displayed are as follows: (1) the vehicle's purpose within the fleet is a “daily rental”, (2) the unit's out of service date should be null, (3) trucks should be included, (4) vehicles that were purchased used should be included (although these vehicles should be excluded from any average mileage calculation), (5) vehicles whose original unit cost equals zero should be excluded, (6) vehicles whose monthly depreciation amount percentage equals zero should be excluded, (7) vehicles that are not yet officially activated within the fleet should be excluded, and (8) the vehicles must have been completely activated within the fleet.

The fleet summary is preferably broken down into three data category columns. A vehicle class column 412 identifies a vehicle class type (e.g., economy, compact, intermediate, full size, etc.). Each row 418a, 418b, . . . 418i corresponds to a different vehicle class. It should be noted that different companies may well use different types of vehicle classes and different criteria for assigning vehicles to vehicle classes. Current fleet column 414 identifies the number of vehicles with each vehicle class for the identified country/group/region. Row 420 includes total numbers for the current fleet column 414 and the current fleet mix column 416. The entries in column 416 identify the percentages that vehicles of the vehicle class sharing the row make up within the overall fleet for the identified country/group/region. The current fleet mix percentages are preferably calculated as: Current Fleet Mix (for Row k) equals 100 multiplied by the Current Fleet Value (for Row k) divided by the Current Fleet Total.

While it is preferred that the fleet summary display section 410 display fleet summary data broken down by vehicle class, it should be noted that this display section 410, if desired by a practitioner of the present invention, could also be used to display current fleet count and current fleet mix data that is further broken down to the YMMS level.

The fleet summary preferably also includes an “as of” date identifier 434 that identifies the date for which the fleet summary data is current (e.g., the time stamped date and time that the fleet database 100 was last updated, which at minimum is preferably a day-to-day update).

Recent activity display section 422 summarizes the most recent activities of the user in the various sections of the fleet management application 102. Typically, section 422 will display a summary of recent reports and/or data tables created by the user as well as links 436 and 437 to such reports/data tables. Link 436 takes the user to screen 216 of the residuals path 212. Link 437 takes the user to screen 224 of the CGF path 220. Column 424 identifies the type of report/data table that the user had recently created. If the report/data table relates to a residual value table, the data displayed in column 424 will preferably identify the fact that the report/data table relates to residual values as well as identify the pertinent YMMS for the latest residual value data viewed by the user (preferably using a descriptive name for the YMMS). If the report/data table relates to a CGF table, the data displayed in column 424 will preferably identify the fact that the report/data table relates to CGF values as well as identify the pertinent vehicle class (e.g., fullsize) for the latest CGF data viewed by the user. Column 426 identifies the pertinent country/group/region for each report/data table, and column 428 identifies the date (and preferably time) upon which each report/data table was last viewed. Rows 430a and 430b identify the particular column values for each recent report/data table.

Quick links display section 460 preferably includes a plurality of links to frequently-used industry sources for vehicle data. Preferably, the links that are displayed to the user are country-specific.

Feature gateway display section 440 serves as a jumping off point for the user to access the residuals path 212 and the CGF path 220 identified in FIG. 2. Preferably, user selection of link 442 provides the user with access to residuals path 212 and user selection of link 444 provides the user with access to CGF path 220. Moreover, it is preferred that home page 208 further include one or more navigation bars 446 to provide the user with similar navigation capabilities as section 440. In the preferred embodiment, navigation bars 446 each include a link 448 back to the home page 208, a link 450 to the residuals path (link 450 corresponds to link 442 in section 440), a link 452 to the CGF path (link 452 corresponds to link 444 in section 440), a link 454 to a “contact us” page that provides pertinent contact information to the user about the fleet management application 102, and a link 456 that is operative to log the user out of the fleet management application 102.

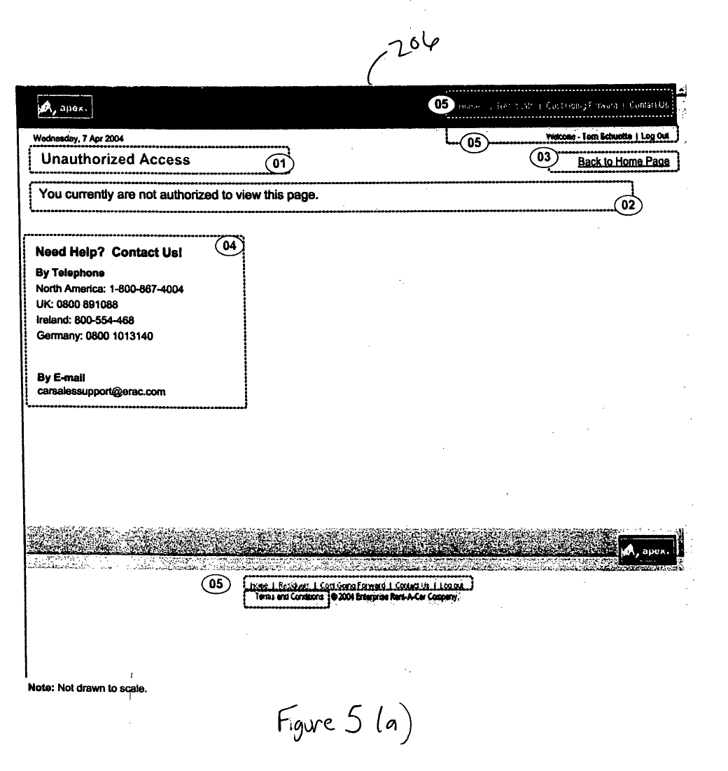

In the event the user tries to navigate from the home page 208 to a page that he/she is not authorized to access, the “unauthorized access” screen 206 (see FIG. 5(a)) will be preferably presented to the user. In the event the user attempts to navigate to a page that is unavailable due to technical problems in the system, the “technical difficulties” screen 210 (see FIG. 5(b)) will preferably be presented to the user.

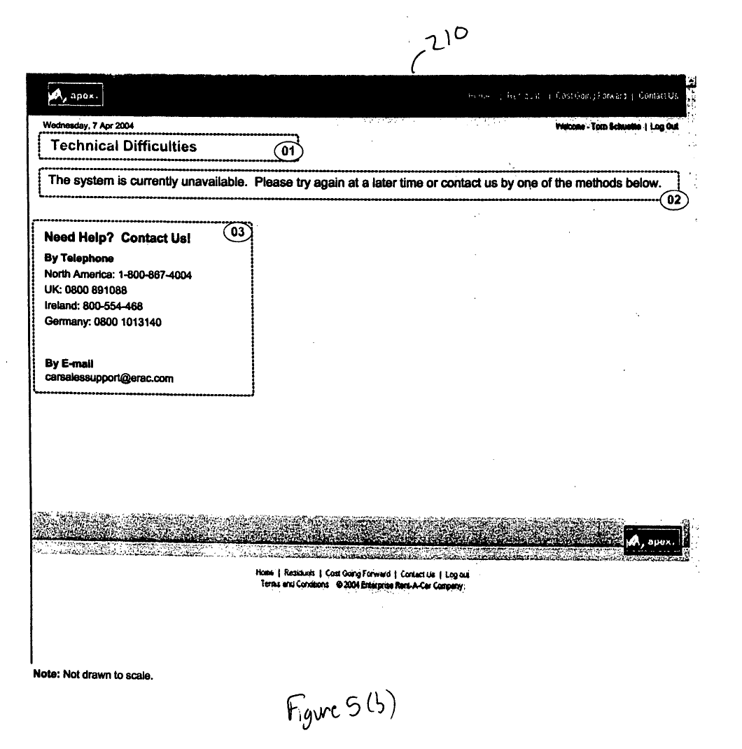

To enter the residuals path 212 and reach the residuals parameter entry screen 214 of FIG. 6, the user can select any of the links 442 or 450 on home page 208. Residuals parameter entry screen 214 includes a current location display section 400 as described in connection with the home page 208 of FIG. 4. Preferably, the current location section 400 of residuals parameter entry screen 214 will default to the country/group/region values that were present on home page 208. However, the user will preferably be free to modify those values subject to the authorization restrictions described above in connection with FIG. 4. Screen 214 also preferably includes a vehicle selection section 600 that lists a plurality of vehicle classes 602a, 602b, 602c, . . . for which the user has the ability to view historical sales calculations and enter residual value forecasts. It is preferred that upon arrival at screen 214, the vehicle class of the YMMS for the most recent residual table in section 422 of the home page 208 be highlighted. However, the user will preferably still possess the ability to select any of the listed vehicle classes. Further, it is worth noting that while in the preferred embodiment, the vehicle selection section 600 lists vehicle classes, a practitioner of the present invention may also choose to have section 600 select vehicles by criteria other than vehicle class, for example, by YMMS.

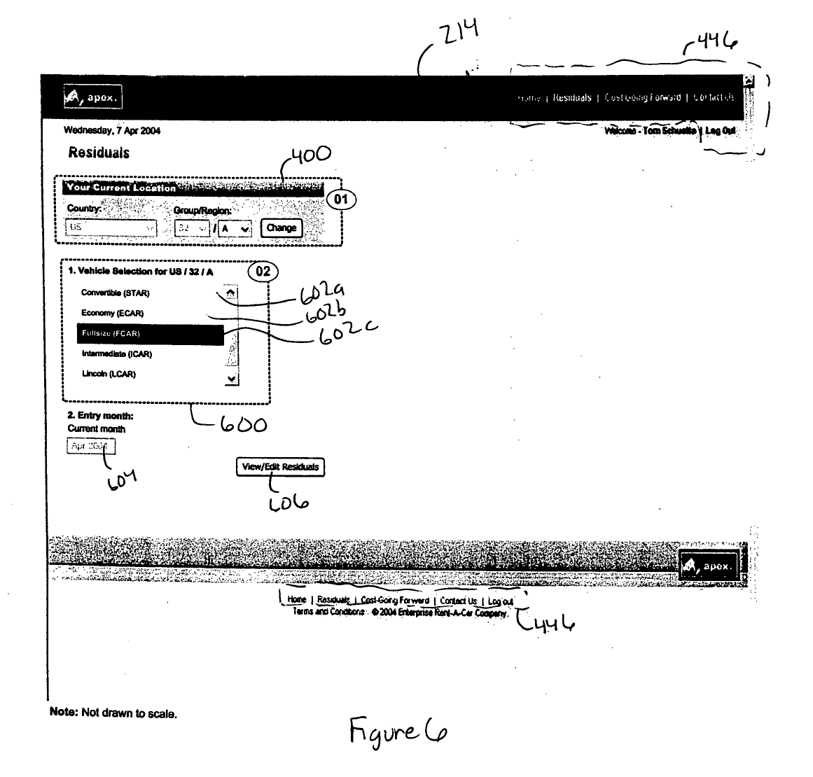

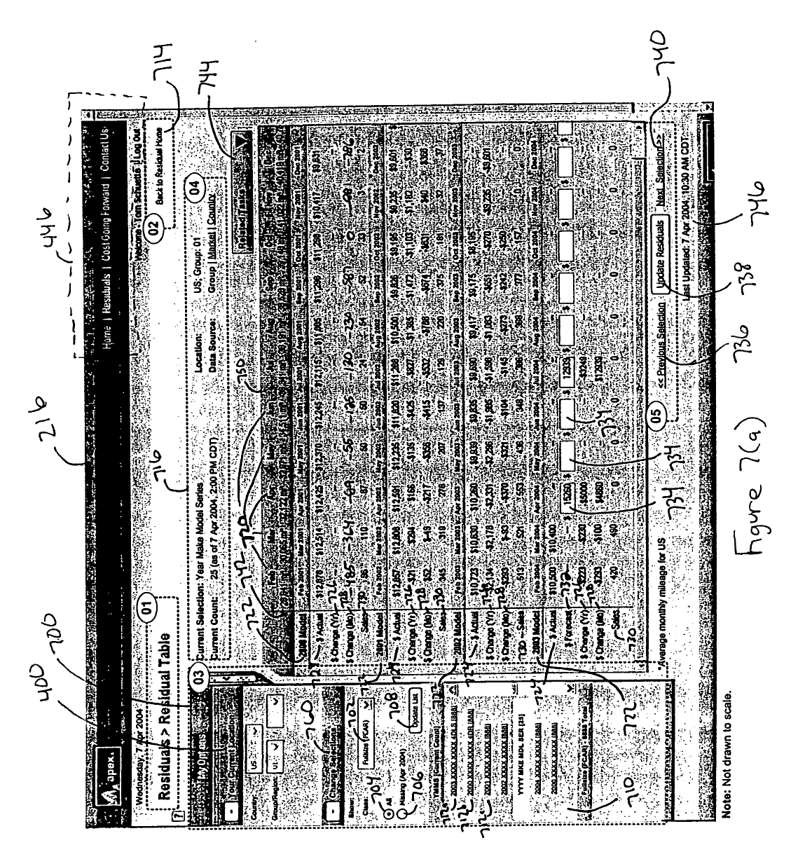

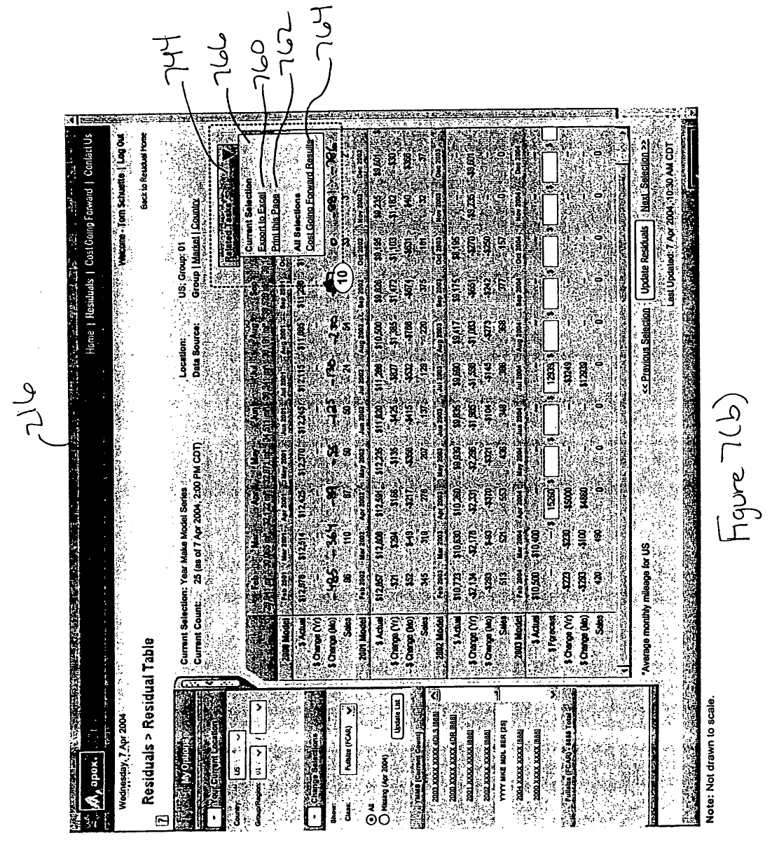

Current month display section 604 notifies the user of the current month for residual value entry. Link 606 is provided to allow the user to proceed to a residual value table screen 216, depicted in FIG. 7(a). Upon user selection of link 606, the residual table screen 216 for the selected vehicle class and country/group/region constraints is displayed.

FIG. 7(a) depicts a preferred residual table screen 216. The preferred residual table screen 216 serves two main purposes. The first purpose is to display historical sales data for the selected YMMS and similar YMMSs within the fleet of interest. By displaying such historical sales data, the user is provided with valuable data for use in predicting the residual values for such YMMSs currently within that fleet. The second purpose is to allow the user to enter estimates for future residual values, the value of which will become apparent when the CGF aspect of the preferred embodiment is discussed.

Among the various sections of the residual table screen 216 are a user options section 700, an information section 716, a related tasks button 744, a residual table 750, and a navigational bar 446. Navigational bar 446 functions as described earlier in connection with home page 208. Also, user selection of link 714 routes the user back to the residuals parameter entry screen 214. Further, time stamp section 746 identifies the date and time the displayed table 750 was last updated (and preferably who (not shown) updated the table).

The user options section 700 preferably includes three sections therewithin: a current location section 400 that is operative as previously described, a change selections section 760, and a YMMS selection section 710. Further, it is preferred that the user be provided with the ability to minimize, maximize, and otherwise selectively size the user options section 700 within the residual table screen 216. For users who have the authorization to change the country/group/region values, it is preferred that a “change” button (not shown) be made available in the current location section 400 to provide the user with the ability to modify country/group/region values in a manner commensurate with his/her level of authorization.

Field 702 within the change selections section 760 allows the user to modify the selected vehicle class for the screen. Field 702 is preferably joined with a drop down menu that contains a list of the vehicle classes with the current location's fleet. Radio buttons 704 and 706 provide the user with the ability to display within YMMS selection section 710 either “all” of the YMMSs within the selected vehicle class or only those YMMSs within the selected vehicle class for which a current residual value report is “missing” for the current month. Preferably, the current month is displayed alongside “missing” radio button 706. Based on any selections by the user within change selections section 760, user selection of the “update list” button 708 will be effective to reload the residual table screen 216 with the modified entries.

The YMMS selection section 710 provides the user with the ability to select the YMMS for the residual table 750. As noted above, the YMMSs listed in section 710 will be either all of the YMMSs within the selected vehicle class for the specified current location (country/group/region) or the YMMSs within the selected vehicle class for the specified location and for which a current month's residual value report is not yet completed, depending on the user input in radio buttons 704 and 706. The sort order for the YMMSs within section 710 is preferably make, year, model, series (alphabetically where applicable and chronologically where applicable), although they are preferably descriptively displayed by YMMS. However, it should be understood that other sort orders can be used. Furthermore, it is preferred that each YMMS listed in section 710 also include an adjacent identification of that YMMS's total count or population within the current location's fleet. At the bottom of section 710, a total vehicle count for the entire vehicle class of the current location's fleet is preferably displayed. The YMMS row 712 for the currently displayed residual table 750 is preferably highlighted in some manner to help notify the user of which YMMS is applicable to the current table 750. By clicking on a row 712 of section 710, the user can choose the YMMS for which the residual table 750 is applicable.

Information section 716 preferably displays to the user a summary of the parameters for which and from which the residual table 750 was created. This summary information includes an identification of the YMMS applicable to the residual table 750, an identification of the total count for that YMMS within the current location's fleet as of a predetermined date (preferably the date that the fleet database was last updated, an identification of the current location (country/group/region) for the residual table 750, and an identification of the data source, which specifies the pool of vehicles within the fleet that will be used for the historical analysis to populate entries in the residual table 750. Through the data source links, the user will have the ability to change the pool of vehicles for which historical analysis is performed to a larger or smaller pool. For example, if a St. Louis group fleet manager feels it would be more helpful to include a larger pool of historical sales in the analysis than just those in the St. Louis area, then that fleet manager will have the capability to expand the pool of historical sales to be analyzed (e.g., to encompass the entire midwest market rather than just the St. Louis group). The preferred data source choices are Group, Market, and Country. If the “Group” choice is selected, then the historical values are calculated from YMMS vehicles within the group of the data source's fleet. If the “Market” choice is selected, then the historical values are calculated from the YMMS vehicles with the market to which the group of the data source's fleet belongs. The choices of how to place groups within larger markets is a design choice, but it is preferred that groups be assigned to their natural geographical areas such as east, south, central, and west. If the “Country” choice is selected, then the historical values are calculated from YMMS vehicles within the country of the data source's fleet. It is worth noting that, preferably, the scope of levels accessible to the user via the data source tool not be limited by the user's authorization level within the company. Further still, practitioners of the present invention may choose different criteria for data source constraints similar in nature to the options discussed in connection with current location display 400.

Residual table 750 presents the user with a vast array of historical sales data for vehicles of a YMMS that is the same or similar to the user-selected YMMS within the data source's fleet. Residual table 750 further allows the user to enter estimations for future residual values for the user-selected YMMS, guided at least in part by the user's analysis of the historical trends displayed via the table 750.

Residual table 750 is preferably formatted in the following manner. The current year values for the selected YMMS vehicle appear as the last row 722 of information on the bottom of the table 750. Directly above the current year, will be historical data for the previous year's YMMS, in the same format as the rows and columns for the current year. Residual table 750 preferably displays the three previous years of data for a YMMS group together with the current year's data. However, it should be understood, that more or fewer than three previous years can be displayed and that the user can be given the ability to specify how many previous years are to be displayed. If there is no historical data available for a similar YMMS in a previous year, then a “-” or the like is preferably displayed in the pertinent row and column.

Along with each year's row, there will preferably be twelve columns corresponding to the months of the year. Preferably, the first two columns correspond to the two previous months, the third column corresponds to the current month, and the next nine columns correspond to the next nine months. The arrangement of columns is preferably updated by the software at midnight on the first of each month. However, other arrangements of months within columns can be used. For example, some practitioners of the present invention may prefer that the columns be displayed in strict January through December order while others may prefer that the current month be listed first with later months following.

While it is preferred that rows in the table correspond to data for different YMMSs and the columns correspond to different months, it should be noted that practitioners of the present invention may choose different row/column arrangements. For example, rather than having columns correspond to months, the columns could correspond to different time periods (e.g., quarterly). Also, the table can be arranged such that some rows correspond to country-level sales of a YMMS, some rows correspond to market-level sales of a YMMS, some rows correspond to group-level sales, and some rows correspond to region-level sales.

In row 742 for each month, the residual table 750 preferably displays an average mileage calculation for previous sales of the same or similar YMMSs in that month. Before explaining these average mileage calculations, it will be helpful to discuss the system's technique for pooling the appropriate historical data.

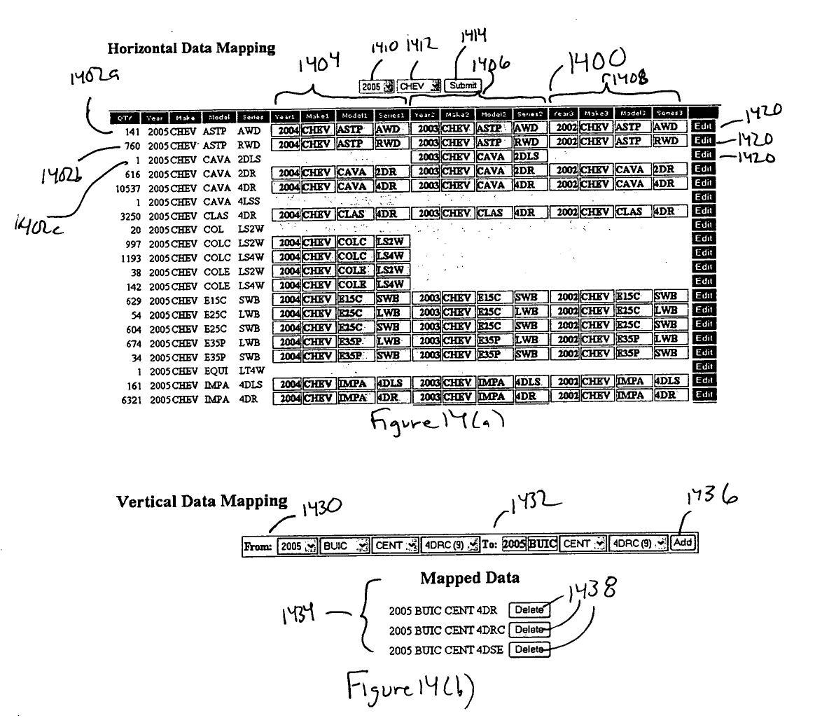

When attempting to estimate future residual values for a particular YMMS such as a 2004 MMS, it will be helpful to know how previous year MMSs have sold. In this case, a YMMS group of the same or similar YMMSs for a user-selected YMMS of a 2004 MMS would be the 2003, 2002, 2001 and so on versions of the MMS, as determined by a user. However, it may be the case that the process of grouping YMMSs into a YMMS group that corresponds to a user-selected YMMS is not so simple as finding matching MMSs for previous years. For example, in some cases, the name of the make, model, and/or series may have changed over time, despite a current YMMS still being the same “type” of vehicle as the older YMMSs. So that the fleet management application can accurately know which YMMSs to take into consideration when performing a historical analysis for a user-selected YMMS, the mapping tools of FIGS. 14(a) and (b) are preferably used. FIG. 14(a) depicts a mapping table 1400 for grouping current YMMSs with older YMMSs to create a YMMS group. In table 1400, the YMMS group is defined as the YMMSs that share a row 1402a, 1402b, 1402c, . . . , etc. Via fields 1410 and 1412, the user can specify a year/make combination to work on. In this example, the selected year/make combination in fields 1410 and 1412 is “2005 Chevy”. Thus, table 1400 lists all YMMSs that are 2005 Chevys. Within the cells of each column group 1404, 1406, 1408, and so on, the user can specify the older YMMSs that are to be mapped to the current YMMS sharing the row, to thereby create a YMMS group. Button 1414 is provided to save the YMMS groups to a database. Buttons 1420 are provided at the end of each row to edit the previous YMMSs that are to be grouped with a current YMMS.

FIG. 14(a) depicts what can be referred to as “horizontal” mapping (mapping older YMMSs with a current YMMS). Another mapping scenario is “vertical” mapping, as shown in FIG. 14(b), which involves matching same year YMMSs together into a YMMS group. This is typically done because, despite a formal name difference between the same year YMMSs, the user has determined that the vehicles are essentially the same for historical analysis purposes. In FIG. 14(b), the user can specify in field 1430 a YMMS that is to be mapped to another same year YMMS (specified in field 1432) to create a YMMS group. Summary section 1434 lists all same year YMMSs that have been mapped together into a YMMS group. “Delete” buttons 1438 are provided for removing particular YMMSs from this group. “Add” button 1436 is provided for adding the YMMS in field 1430 to the group.

A good case study for mapping is the Chevy Malibu. Going back to 2002, consider the following vehicle types: 2002 Chevy Malibu, 2003 Chevy Malibu, 2004 Chevy Classic, 2004 Chevy Malibu, 2005 Chevy Classic, and the 2005 Chevy Malibu. When mapping similar vehicle types together for the 2005 Chevy Classic, it is preferred that the 2002 Chevy Malibu, 2003 Chevy Malibu, and 2004 Chevy Classic be grouped therewith. When mapping similar vehicle types together for the 2005 Chevy Malibu, it is preferred that only the 2004 Chevy Malibu be grouped therewith. This mapping result arises from a change in design from Chevy wherein the 2004 Chevy Malibu was sufficiently different from previous years of the Malibu to render sales data for previous year Malibus relatively immaterial thereto. However, the Chevy Classic introduced in 2004 was sufficiently similar to the previous year Malibus so as to justify their user-defined grouping for historical sales analysis.

Once the appropriate YMMSs have been mapped into YMMS groups, a historical analysis of the average mileages by month of sale for a user-selected YMMS can be performed. This average mileage will be based on the odometer readings at the time of wholesale/retail sale for vehicles in the YMMS group corresponding to the user-selected YMMS. The formula used to calculate the average mileage is the sum of the odometer readings (at the time of sale) for all vehicles matching the YMMS group that were sold in the same month as the column in question divided by the total number of vehicles matching the YMMS group that were sold in the same month as the column in question, wherein the sales that are included in this analysis are the sales dating back to the earliest year for which reliable sales data is available (which is the year 1998 in the preferred embodiment). However, fewer years (or more years) of sales data could be used to calculate each month's average mileage.

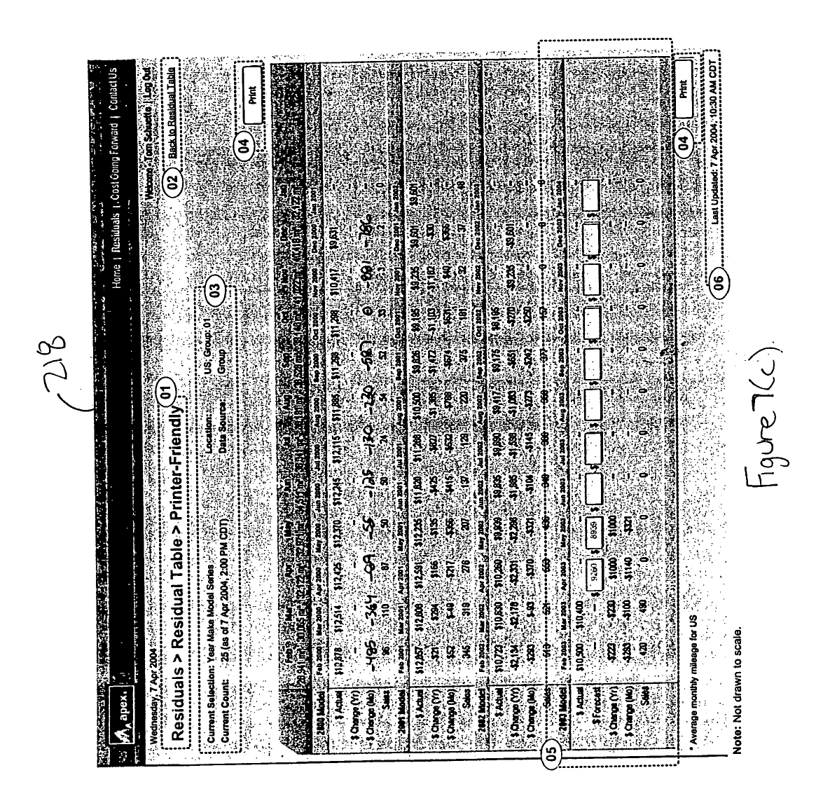

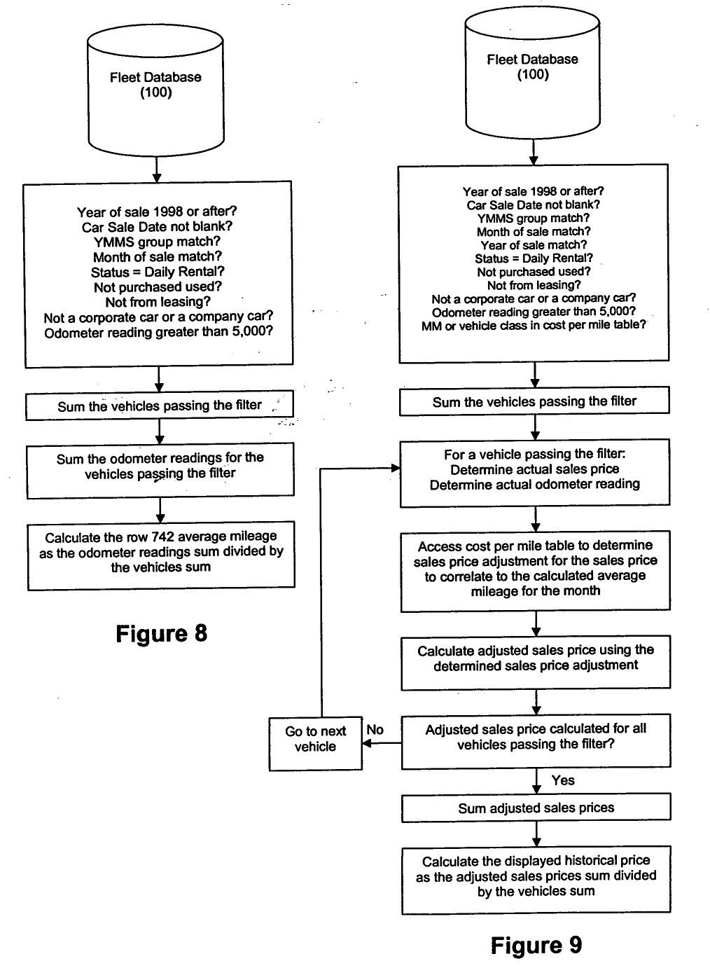

Furthermore, to be included in the pool of past sales used in the calculation, it is preferred that a vehicle sale for a member of the YMMS group must meet these additional criteria: (1) the vehicle's sale date must not be blank, (2) the vehicle must have had a status of “daily rental” prior to the sale, (3) the vehicle was not purchased used, (4) the vehicle must not have been brought from leasing nor is a corporate or company car, and (5) the vehicle must have had more than 5,000 miles on the odometer at the time of sale. FIG. 8 is a flowchart illustrating how the average mileage is calculated for each month. While it is preferred that a single average mileage be calculated for all YMMSs in a YMMS group that were sold in a given month, it should be understood that a practitioner of the present invention may choose to calculate and display a different average mileage for each YMMS within the group. Also, it is preferred that for any YMMS groups having no sales, that the average mileage determination be rolled up to the MM level. If no sales are found at the MM level, it is preferred that the average mileage determination be further rolled up to the vehicle class level.

In row 726 for each model year row 722, the monthly column entries will display a calculated historical sales price for each year of YMMS within the YMMS group, wherein the historical sales prices have been normalized to the corresponding average mileages in row 742. In the example of FIG. 7(a), the $12,878 value in the February column of row 724 for the YMMS displayed in section 716 represents a historical value determined in accordance with the present invention for that YMMS that was sold in February 2001 with 26,941 miles on it (the row 742 value for February). Likewise, the $10,723 value in the February column of row 724 represents a historical value determined in accordance with the present invention for that YMMS that was sold in February 2003 with 26,941 miles on it.

Conceptually, with this technique the actual sales price values and actual mileage values for previously sold vehicles of a particular YMMS group can be thought of as a data group. The goal of the concept is to normalize each sales price value in the data group to a “representative” data group member (the representative member preferably being the average mileage value computed in accordance with FIG. 8 from the data group's actual mileage values (or a subset thereof)). As described in greater detail below, this normalization can be achieved by adjusting each vehicle's actual sales price value corresponding to that vehicle's actual mileage as compared to the representative member (the average mileage value). To aid this adjustment, a cost per mile data table is preferably accessed. Once the actual sales prices have been so normalized, select subsets of the normalized sales prices can be combined to calculate appropriate average normalized sales prices. FIG. 9 illustrates a preferred implementation of this concept.

With reference to FIG. 9, for each of the vehicles passing the following filter constraints: (1) the vehicle's sale date must not be blank, (2) the vehicle must have had a status of “daily rental” prior to the sale, (3) the vehicle was not purchased used, (4) the vehicle must not have been brought from leasing nor is a corporate or company car, (5) the vehicle must have had more than 5,000 miles on the odometer at the time of sale, (6) the vehicle's year of sale must match the year in question, and (7) the vehicle's MM or vehicle class must have a matching entry in the cost per mile table (discussed below), the software will determine the vehicle's actual sale price and actual odometer reading at the time of sale (these values being stored in the fleet database 100). Thereafter, the software will seek to calculate an adjusted sales price that represents what the vehicle sales price would have been had the odometer reading at the time of sale matched the calculated average mileage in row 742. To do so, a cost per mile table is preferably used. The cost per mile table displays an estimated vehicle price (by vehicle type) associated with an odometer reading for a vehicle of that type. An exemplary cost per mile table is shown below:

Cost per mile Table for a YMMS:

| Miles | Cost |
|---|---|
| . | . |
| . | . |
| . | . |
| 12,000 | $7,841 |
| 13,000 | $7,795 |
| 14,000 | $7,750 |
| 15,000 | $7,704 |
| 16,000 | $7,658 |
| 17,000 | $7,613 |
| . | . |
| . | . |
| . | . |

Using this table as an example, and assuming that a vehicle's (say, a hypothetical YMMS of a 2004 xxxx yyyy zzzz) actual sales price is $8,700, that vehicle's actual odometer reading at the time of sale was 12,300 miles, and that the average mileage to which the sales price will be adjusted is 15,400 miles, then the calculation of an adjusted (or normalized) sales price will proceed as follows.

First, one would look to the cost per mile table to find an entry in the table for the vehicle's actual mileage, which in this example is 12,300. If a matching mileage entry is found in the table, then the “cost” parameter is easily set to be the cost value sharing the row with the matching mileage entry. However, if a matching entry is not found, then interpolation (preferably straight line interpolation) based on the next lower and next higher table entries can be used to find cost. In this example, interpolation will be needed. Thus, one preferably first calculates the cost per mile between 12,000 miles and 13,000 miles which comes out to $46 ($7,841-$7,795) for 1,000 miles, or 4.6 cents per mile. Using this cent per mile adjuster, the next step is to find what the appropriate entry in the table would be for a mileage of 12,300. Given that each additional mile added to the vehicle after 12,000 miles (and before 13,000 miles) is assumed to drop 4.6 cents from the vehicle's sales price, it can be determined that 300 additional miles on the vehicle would drop $13.80 (0.046 times 300) from the value of the vehicle at 12,000 miles. Thus, the appropriate cost entry in the table for a 2004 xxxx yyyy zzzz at 12,300 miles would be $7,827.20.

Next, the appropriate cost entry in the table is determined for a 2004 xxxx yyyy zzzz with average mileage (15,400) thereon. If a matching mileage entry is found in the table, then the “cost” parameter is easily set to be the cost value sharing the row with the matching mileage entry. However, if a matching mileage entry is not found, then the same interpolation process described above can be followed. In this example, interpolation will be needed. The cents per mile adjuster between 15,000 miles and 16,000 miles is readily calculated to be $46 (7,704 minus $7,658) for 1,000 miles, or 4.6 cents per mile. Then the table's cost entry for 15,400 miles can be readily determined. Given that each additional mile added to the vehicle after 15,000 miles (and before 16,000 miles) is assumed to drop 4.6 cents from the vehicle's sales price, it can be determined that 400 additional miles on the vehicle would drop $18.40 (0.046 times 400) from the value of the vehicle at 15,000 miles. Thus, the appropriate cost entry in the table for a 2004 xxxx yyyy zzzz at 15,400 would be $7,685.60.

Next, the table's cost difference for a 2004 xxxx yyyy zzzz with 12,300 miles (the actual mileage) and a 2004 xxxx yyyy zzzz at 15,400 miles (the average mileage) is determined. This cost difference is readily computed to be $141.60 ($7,827.20 minus $7,685.60).

Using this calculated cost difference, the actual sales price of $8,700 at 12,300 miles can be normalized to a value at 15,400 miles by reducing the actual sales price by the calculated cost difference. Accordingly, $8,700 at 12,300 miles would be normalized to $8,558.40 at 15,400 miles.

This $8,558.40 represents a normalization of the vehicle's actual sales price to the average mileage, thereby providing an indicator of what the sales price for the vehicle would have been had the vehicle had 15,400 miles on the odometer at the time of sale rather than 12,300 miles.

If the vehicle's actual odometer reading at the time of sale is less than the average mileage to which the sales price is to be adjusted, then it can be expected that the sales price adjustment will be a downward adjustment, as in the previous example. If the vehicle's actual odometer reading at the time of sale is greater than the average mileage to which the sales price is to be adjusted, then it can be expected that the sales price adjustment will be an upward adjustment, as in the following example. Assume that a vehicle's actual sales price is $8,000, that vehicle's actual odometer reading at the time of sale was 15,000 miles, and that the average mileage to which the sales price will be adjusted is 13,000 miles. In this case, the calculation of an adjusted sales price will proceed as follows.

First, one would look to the cost per mile table to find a cost entry in the table corresponding to the vehicle's actual mileage (15,000 miles), which in this example is $7,704 (no interpolation would be needed because an exact matching mileage entry is found in the table). Next, the table's cost entry for the average mileage of 13,000 miles is determined. In this example, the table's cost is $7,795 (once again, no interpolation is needed) for 13,000 miles. Once the table entries corresponding to the cost at the actual mileage and the average mileage are known, the difference between these two values can be calculated. In this example, the difference is $91. The adjusted sales price for the vehicle is then $8,091 which represents the actual sales price plus the calculated difference.

It should be noted that the cost per mile table shown above is exemplary only. Each practitioner of the invention may choose to populate the cost per mile table entries with values that correspond to their own business judgment. A preferred technique for creating the cost per mile table is described in Appendix A attached hereto. As described in the flowchart of FIG. 9, this sales price adjustment is performed for each of the vehicles qualifying for that model year's month's column in the residual table 750. Thus, with reference to FIG. 7(a), this adjustment process will operate on all 96 vehicles for model year 2000 MKE MDL SER that were sold in February 2001. After following the technique of FIG. 9, the average historical sales price in February 2001 for 2000 MKE MDL SERs was found to be $12,878 for a 2000 MKE MDL SER having an odometer reading of 28,941 miles. For all 276 vehicles for model year 2001 MKE MDL SER that were sold in April 2002, the average historical sales price was found to be $12,591 for a 2001 MKE MDL SER having an odometer reading of 32,122 miles.

After all of the entries for rows 724 have been populated with the calculated average historical sales price normalized to that month's average mileage, then the entries for rows 726 and 728 can be automatically populated. Rows 726 represent the yearly sales price changes for YMMSs within the YMMS group sold that month relative to YMMSs within the YMMS group sold that month during the previous year. Essentially, the yearly sales price change for Month M during Year Y is the calculated historical sales price in row 724 for Month M and Year Y minus the calculated historical sales price in row 724 for Month M and Year Y−1. In the example of FIG. 7(a), it can be seen that the row 726 entry for April 2002 is the row 724 entry for April 2002 minus the row 724 entry for April 2001. Rows 728 represent the monthly sales price changes for YMMSs within the YMMS group sold that month relative to YMMSs within the YMMS group sold during the previous month. Essentially, the monthly sales price change for Month M during Year Y is the calculated historical sales price in row 724 for Month M and Year Y minus the calculated historical sales price in row 724 for Month M−1 and Year Y (although when the month in question is January, December of the previous year will be used as the reference point). In the example of FIG. 7(a), it can be seen that the row 728 entry for April 2002 is the row 724 entry for April 2002 minus the row 724 entry for March 2002.

The rows 730 within table 750 are automatically populated with total vehicle sales counts for each month, as determined by the sum of vehicles passing the filter of FIG. 9.

For any data entries for which no data is available, a “-” is preferably displayed in the pertinent field. For example, because the year 2000 models are the earliest models shown in table 750, it is preferred that row 726 for model year 2000 be left blank because there is no displayed model year 1999 with which to compare the yearly sales price changes.

For the current model year, an additional row 732 will be provided in which the user can input forecasted residual values in fields 734 for the selected YMMS. As this row represents a future prediction, it is present only beginning with the current month onward (and is either not present or left blank for previous months). When determining future residual value(s), not only will the user be able to look to year-year historical sales prices normalized to an average mileage, but the user will also be able to look to month-to-month historical sales prices. The month-to-month view will allow users to get a sense for how sales price will decrease or increase from month to month as a YMMS ages from month to month. It is believed that the combination of these beneficial historical views with the user's own business knowledge will enable to user to more accurately estimate future residual value than was available with previous known forecasting systems. These residual value forecasts will help drive the CGF analysis described below.

Once the user has completed a desired number of residual value forecasts in table 750 for the selected YMMS, user selection of “update residuals” button 738 will be operative to save the table 750 in the database and automatically populate the year-to-year and month-to-month changes in rows 726 and 728 as appropriate corresponding to the user-entered residual value(s). However, it is also preferred that table 750 be automatically saved whenever the user navigates to a new page from page 216 (although upon such navigation it may be preferred that a pop-up window ask the user if the table 750 is to be saved). If the user wishes to create/retrieve table 750 for the next YMMS listed in section 710, the user can click on the “next selection” link 740. If the user wishes to create/retrieve table 750 for the previous YMMS listed in section 710, the user can click on the “previous selection” link 736. If a residual table 750 is retrieved for which the forecasted values are more than 30 days old, it is preferred that a warning message to the effect of “values over 30 days old: please update” be displayed on screen 216, preferably just above table 750, below section 710 and to the left of the related tasks button 744.

As shown in FIG. 7(b), the related tasks button 744 is preferably selectable by the user to call up drop down menu 766. Menu 766 preferably provides the user with a selectable link 760 that is operative to export the displayed table 750 to Microsoft Excel, a selectable link 762 that is operative to display printer-friendly page 218 for the displayed table 750 (see FIG. 7(c)), and a selectable link 764 that is operative to route the user into the CGF path 220 at CGF results screen 224 (the CGF results screen being displayed for the vehicle class applicable to table 750).

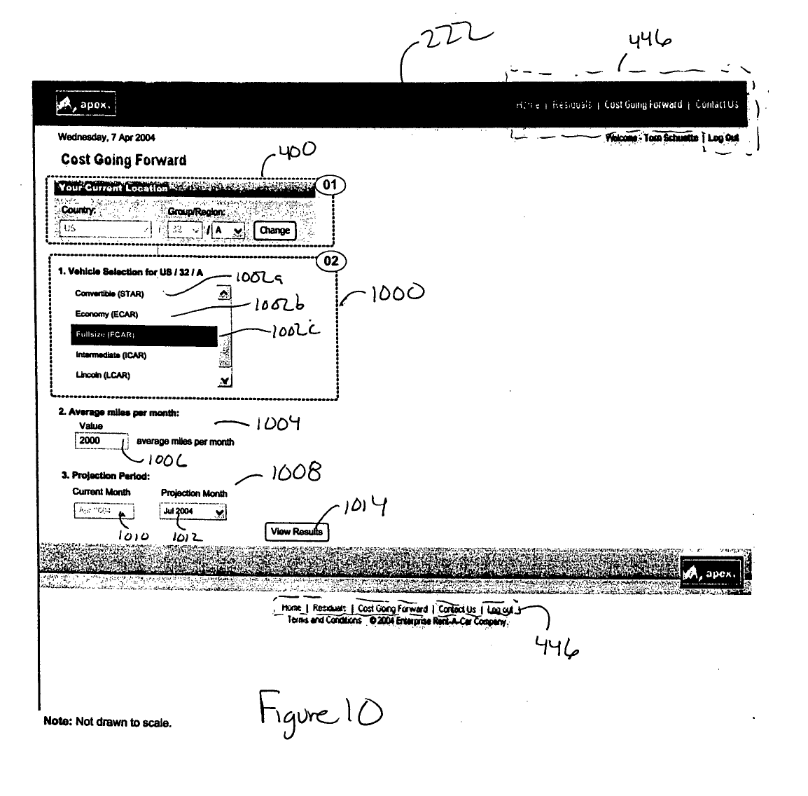

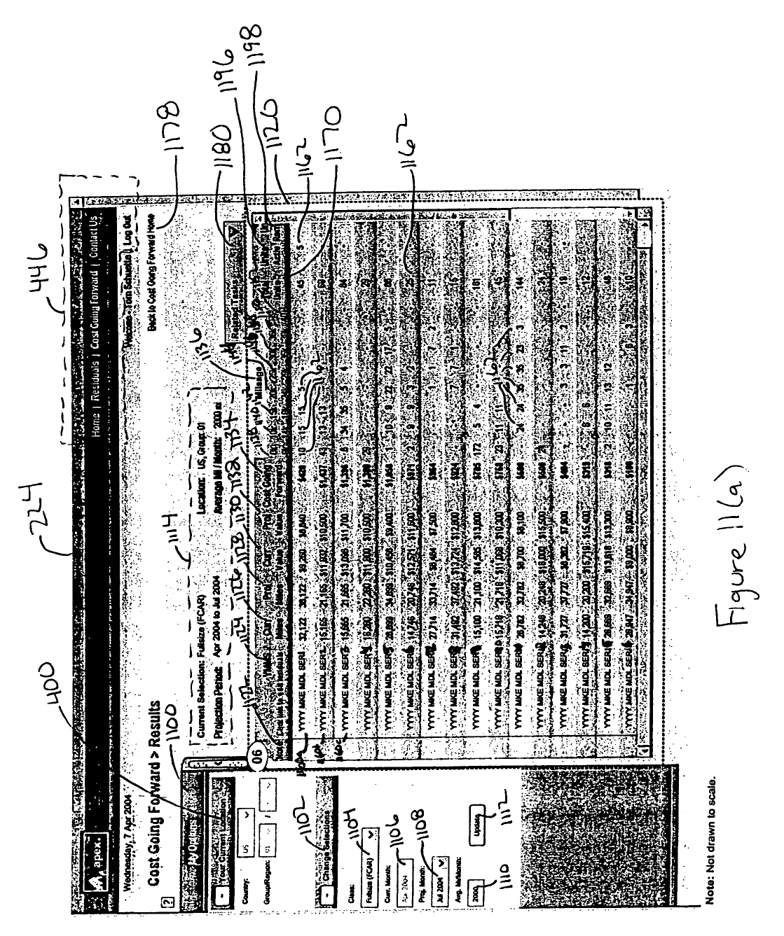

Returning to FIGS. 2 and 4, user selection of links 444 or 452 on home page 208 will cause the user to enter the CGF path 220. FIG. 10 illustrates a preferred CGF parameter entry screen 222 at the start of the CGF path 220. CGF parameter entry screen 222 preferably includes a current location section 400 as previously described for other screens, a vehicle class selection section 1000, an average miles per month input section 1004 and a projection period input section 1008. Using values entered by the user for the various parameters of screen 222, the software will preferably perform a CGF analysis for the YMMSs of a selected vehicle class.

As previously described, current location section 400 displays the current country/group/region values for the user and allows the user to modify the current country/group/region values (depending on the user's level of authorization).

Vehicle selection section 1000 presents the user with a list of selectable vehicle classes in rows 1002a, 1002b, 1002c, . . . for use in the CGF analysis. The vehicle classes are preferably listed in alphabetical order. Further, the vehicle class corresponding to the vehicle class of the most recent CGF analysis by the user is preferably highlighted upon the user's arrival to page 222.

Average miles per month input section 1004 preferably provides the user with a field 1006 in which the user can enter a forecasted monthly mileage that the user expects for vehicles of the selected vehicle class in the near future. At the beginning of each calendar month, this value is preferably recalculated based on past history of the selected vehicle class, and this new average is then preferably displayed as a default value in field 1006. When a user enters a new value in field 1006, it is preferred that this new value be saved as the user's preference such that the new value will be appear by default for the remainder of the month when the re-accesses screen 222 for the selected vehicle class. Once that month ends however, it is preferred that a new default value be displayed. Preferably, the user will also be restricted from entering a value in field 1006 that is less than 1000 miles or greater than 9,000 miles. It is worth noting that section 1004 can also include a display of a suggested entry for field 1006, the suggested entry being derived data in the fleet database 100. This entry can either be displayed to the user in a text field or it can be displayed to the user as a selectable option (together with a second field for a user-entered value). It is preferred that this suggested entry, as well as a new default value in field 1006, be calculated by averaging the monthly mileages for all vehicles in the database that meet the following constraints: (1) the vehicle must be a daily rental, (2) the vehicle must have been a daily rental for longer than 35 days, (3) the vehicle must have more than 5,000 miles on its odometer, (4) the vehicle's average monthly mileage must not be greater than 9,000 miles, and (5) the vehicle must not have been purchased used.

Projection period input section 1008 preferably allows the user to specify the projection period for the CGF analysis. Field 1010 displays the current month for the projection period. Field 1010 is preferably display only. The user inputs the end month for the projection period in field 1012. Preferably, the projection's end month can be from one to six months from the current month. These end months that are available for selection can be listed in a drop down menu associated with field 1012. However, it is worth noting that more or fewer months can be used in the projection period. Further, it is worth noting that this projection period need not be specified in terms of months at all. Other time periods (for example, quarters) could be used.

Once the user has entered the pertinent parameter values on page 222, user selection of the “view results” button 1014 will be effective to launch a CGF analysis for the YMMSs of the selected vehicle class for the displayed country/group/region, using the average monthly mileage in field 1006 and the projection period specified by fields 1010 and 1012. The results of this CGF analysis will be presented to the user via the CGF analysis results screen 224.

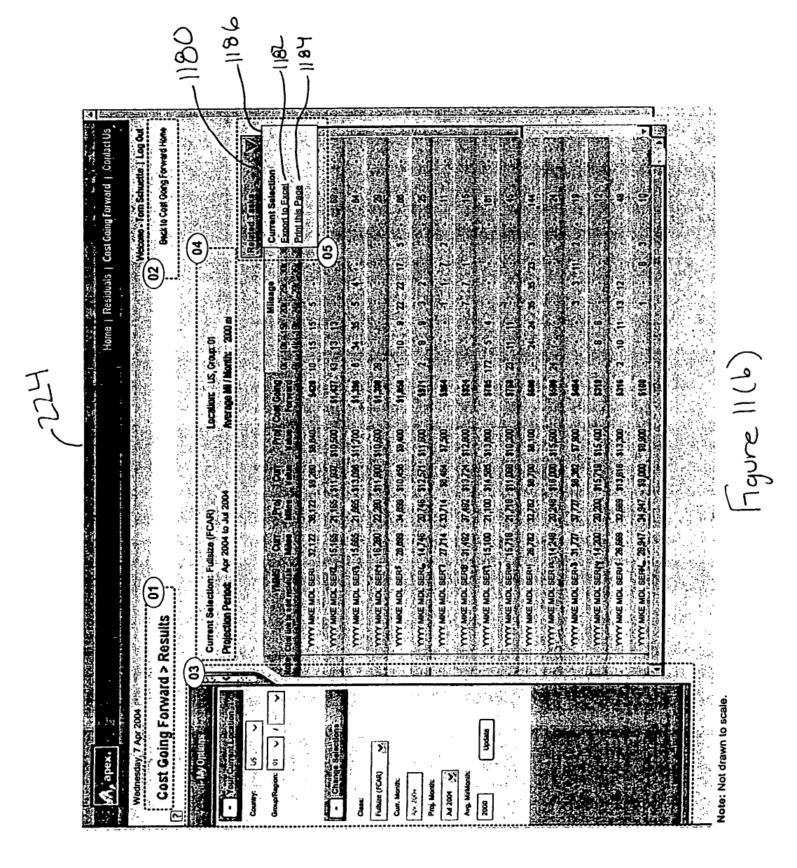

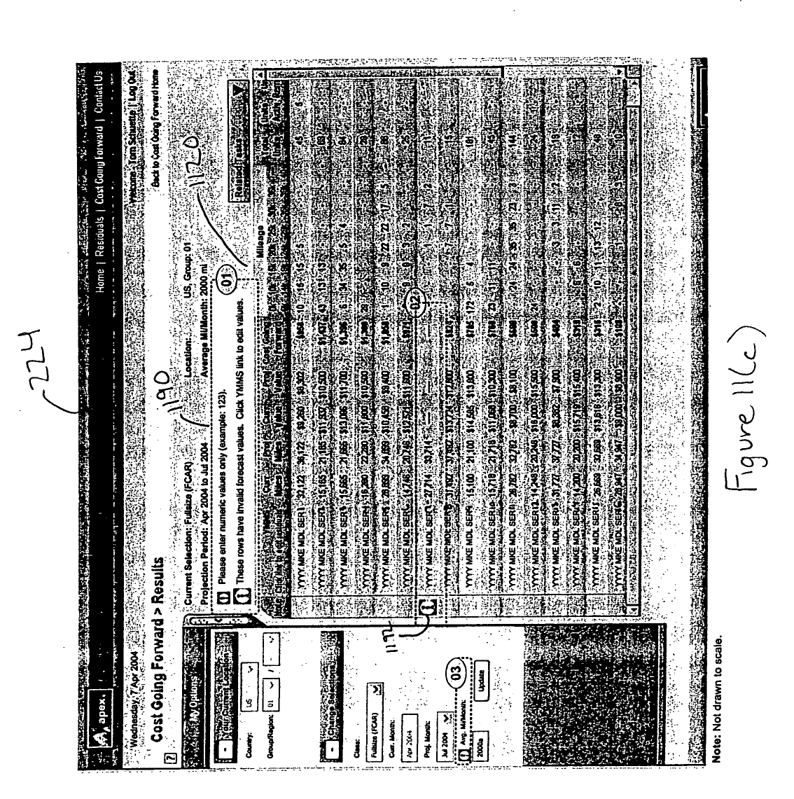

FIG. 11(a) illustrates a preferred CGF analysis results screen 224. The CGF results page 224 has two primary purposes—the first being to display the projected costs going forward for all of the YMMSs in the selected vehicle class and the second being to display the number of vehicles for each YMMS within a plurality of specified mileage ranges. Among the various sections of the CGF analysis results screen 224 are a user options section 1100, an information section 1114, a related tasks button 1180, a CGF results table 1120, and a navigational bar 446. Navigational bar 446 functions as described earlier in connection with home page 208. User selection of link 1178 routes the user back to the CGF parameter entry screen 222.

Within the user options section 1100 is a current location section 400 that is operative as previously described. Also included in section 1100 is a change selections section 1102. Section 1102 provides a field 1104 that allows the user to change the vehicle class selected for the CGF results (preferably, the vehicle class options are presented to the user via a drop down menu associated with field 1104). By default, field 1102 preferably displays the currently selected vehicle class. Section 1102 also preferably provides a field 1106 that notifies the user of the starting month (i.e., the current month) in the projection period as well as a field 1108 that allows the user to enter a new ending month for the projection period. Field 1108 is preferably defaulted to the currently selected end month for the projection period. Further, section 1102 preferably includes a field 1110 in which the user can enter a new average miles per month value. Field 1110 preferably defaults to the current value for the average monthly mileage. “Update” button 1112 is preferably provided in section 1102 to allow the user to refresh screen 224 in accordance with any updated values in section 1102.

Information section 1114 informs the user with displays of the currently selected vehicle class, the currently selected location (country/group/region), the currently selected projection period and the current value for average miles per month.

The heart of the CGF results page 224 is found in the CGF results table 1120. The CGF results table 1120 provides current value and future value projections for the YMMSs of the selected vehicle class. Each row 1160a, 1160b, 1160c, . . . in column 1124 corresponds to a different YMMS within the selected vehicle class. Each YMMS listed in row 1160 preferably also serves a link to the most recent residual value table screen 216 for that YMMS.

For each listed YMMS in rows 1160, there is preferably a column 1126 for the current mileage as of the current month of the projection period. This value is the average mileage value in row 742 of residual table 750 for the current month and the YMMS in question.

For each listed YMMS in rows 1160, there is also preferably a column 1128 for the projected average mileage for that YMMS at the end of the projection period. This value is the current miles value in column 1126 for that YMMS plus the average miles per month selected for the CGF analysis multiplied by the number of months in the projection period.

For each listed YMMS in rows 1160, there is also preferably a column 1130 for the current residual value for that YMMS. This value is the residual value entered by the user in field 734 of residual table 750 for the current month.

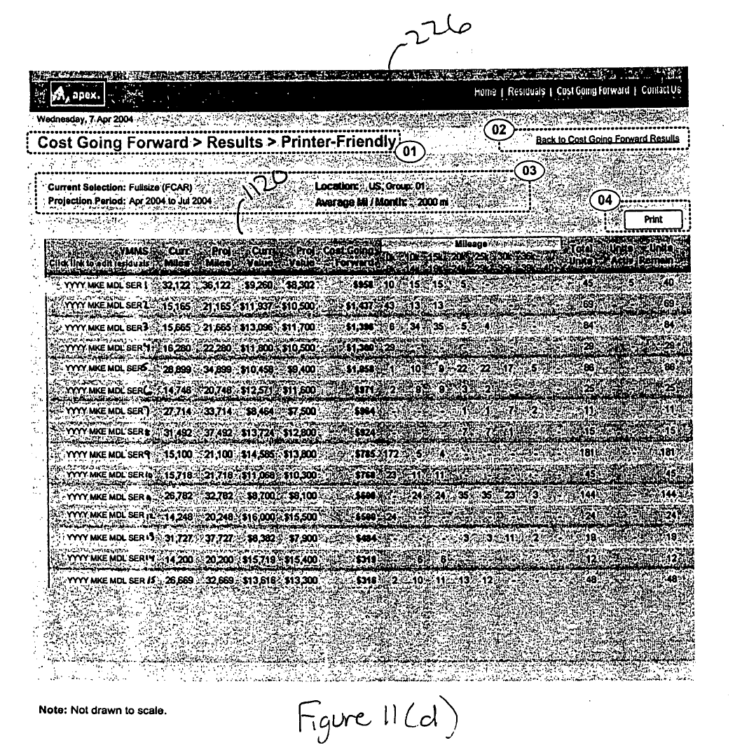

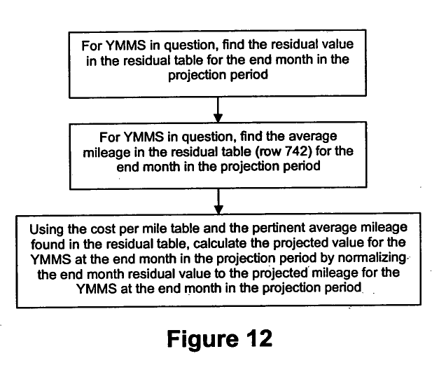

For each listed YMMS in rows 1160, there is also preferably a column 1132 for the projected residual value for that YMMS at the end of the projection period. This value is calculated using the residual value entered for that YMMS in field 734 of the residual table 750 for the end month of the projection period. This residual value is then adjusted for the projected mileage that the YMMS is expected to have at the end of the projection period in accordance with a cost per mile table that relates vehicle values on a mileage basis. FIG. 12 is a flowchart describing a preferred implementation of this normalization process.

An example will help illustrate how the projected values in column 1132 are calculated. Assume that the pertinent values in the residual table 750 for the YMMS in question at the end month in the projection period are as follows for a 2004 xxxx yyyy zzzz:

May: $9,500 for an average mileage of 12,000 miles

July: $8,400 for an average mileage of 14,000 miles

Further, assume a two month projection and an average miles per month value of 2,000 miles. Further assume that the current month is May. Using these numbers, the projected mileage will be 16,000 (the base mileage of 12,000 plus two months of 2,000 miles). The goal is to calculate the projected value for a 2004 xxxx yyyy zzzz at 16,000 miles from the residual values of $8,400 at 14,000 miles in July and $9,500 at 12,000 miles in May. In making this projection, the exemplary cost per mile table shown above will be used. This table is preferably created and used in the same manner described above in connection with the residual table and as set forth in Appendix A.

From this table, it can be seen that the cost adjustment between 14,000 miles and 16,000 miles is a downward adjustment of $92. Accordingly, to normalize the end month residual value for the YMMS to the projected mileage, the end month residual value needs to be decreased by $92. Therefore, in this example, the projected value for the 2004 xxxx yyyy zzzz in July assuming 2,000 miles per month will be $8,308 ($8,400 minus $92).

If exact matching entries are not found in the cost per mile table for the end month average mileage and/or the end month projected mileage, then interpolation can be used as described in connection with the residual table 750 to arrive at the appropriate table cost values.

For each listed YMMS in rows 1160, there is also preferably a column 1134 for the cost going forward (CGF) for that YMMS at the end of the projection period. This CGF value is calculated as the difference between the projected value for the YMMS in column 1132 and the current value for the YMMS in column 1130. These CGF values display to the user the expected changes in value for each YMMS from the start of the projection period to the end of the projection period. The YMMSs in table 1120 are preferably sorted by their CGF values in column 1134 such that the YMMSs with the largest negative CGF value are displayed at the top of the table. However, this need not be the case.

An additional preferred feature of the CGF results table 1120 is the mileage band section 1136. Section 1136 comprises a plurality of columns 1138 through 1152, each column corresponding to a different range of mileage values, preferably progressing from lower mileages to higher mileages. Populating each row in column 1138 through 1152 is preferably a count of the number of vehicles for that row's YMMS that fall within the pertinent mileage ranges. The entries in column 1170 for each YMMS correspond to the total count of vehicles in the fleet of interest for that YMMS (subject to the country/group/region and other constraints previously described). These classifications and counts of YMMS vehicles are readily achieved by filtering data in the fleet database. In the example of FIG. 11(a), it can be seen that the count for the YMMS of YYYY MKE MDL SER5 is 86, with 1 of those falling within the 0 to 9,999 mileage range, 10 falling within the 10,000 to 14,999 mileage range, 9 within the 15,000 to 19,999 mileage range, 22 falling within the 20,000 to 24,999 mileage range, 22 falling within the 25,000 to 29,999 mileage range, 17 falling within the 30,000 to 35,999 mileage range, and 5 falling within the 36,000 to 39,999 mileage range. It is worth noting that these mileage band breakdowns are only preferred breakdowns. Other mileage band breakdowns can readily be used in the practice of the present invention.

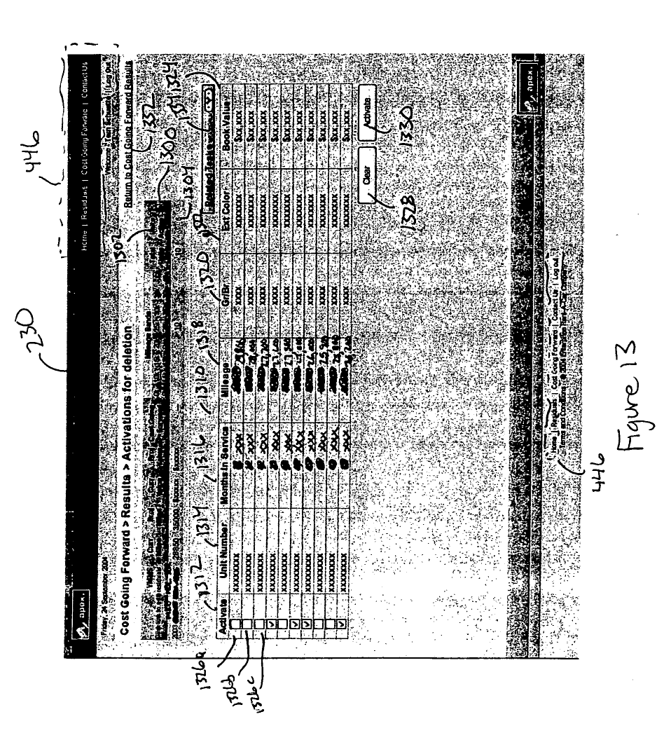

Furthermore, it is preferred that each entry 1162 in the mileage band section 1136 serve as a link to an activation page for those vehicles in the YMMS mileage band. As will be described in connection with FIG. 13, from the activation page, the user can flag specific vehicles for deletion from the fleet.

For each listed YMMS in rows 1160, there is also preferably a column 1196 for identifying a count of YMMS vehicles within the pertinent total number of column 1170 that have been activated for deletion from the current location's fleet. The entries in column 1198 for each row 1160 thus identifies a count for the remaining unactivated YMMS vehicles within the pertinent column 1170 total count.

Furthermore, it is preferred that each YMMS row in table 1120 include a column 1122 that provides warning notes to the user. For example, in rare circumstances a CGF value may be found to be positive. It is preferred that such anomalous values be flagged for the user's attention so that the user can evaluate the accuracy of the underlying data (e.g., the residual value forecasts). To do so, a warning icon 1192 can be displayed in the appropriate row of column 1122. Additionally, descriptive language for the warning icons 1192 can be displayed on screen 224 above the table 1120, below section 1114 and to the left of related tasks button 1180. Additional examples of warnings for the user can be an “invalid forecast values in the residual table” warning and a “please, enter only numeric values” warning, as shown in FIG. 11(c).

As shown in FIG. 11(b), the related tasks button 1180 is preferably selectable by the user to call up drop down menu 1186. Menu 1186 preferably provides the user with a selectable link 1182 that is operative to export the displayed table 1120 to Microsoft Excel and a selectable link 1184 that is operative to display printer-friendly page 226 for the displayed table 1120 (see FIG. 11(d)).

As previously mentioned, if the user selects one of the links 1162 in CGF results table 1120, the activations screen 230 of FIG. 13 is preferably displayed. From this screen, the user is provided with the ability to flag for deletion from the fleet specific vehicles in the YMMS meeting the mileage band constraints of link 1162. Activations screen 230 preferably includes an information section 1300, an activations table 1310, a related tasks button 1334, and a navigation bar 446. Link 1332 is selectable by the user to route the user back to the CGF analysis results screen 224 from which he/she came.

Information section 1300 provides the user with the information presented in the row 1160 in the CGF results table 1120 for the YMMS corresponding to the link 1162 that was selected by the user. However, the only mileage band count that will be shown in section 1300 is preferably the count for the link 1162 that was selected by the user. It is also preferred that the activated count from column 1196 for the pertinent row in CGF table 1120 be identified in column 1302.

The activations table 1310 preferably displays pertinent data about each listed fleet vehicle in the selected YMMS mileage band and further allows the user to flag specific vehicles for deletion from the fleet. Each row 1326a, 1326b, 1326c, . . . in the table 1310 corresponds to a different vehicle in the fleet meeting the YMMS and mileage band constraints. Column 1314 displays the unique identifier for each vehicle. Column 1316 identifies how many months each vehicle has been in service. Column 1318 identifies the latest odometer readings for each vehicle. Column 1320 identifies the group and branch location where the vehicle resides Column 1322 identifies the exterior color for each vehicle. Lastly, column 1324 identifies the book value for each vehicle (as determined by an accounting or financial department)

Based on the user's assessment of which vehicle(s) listed in table 1310 should be deleted from the fleet and sold as a used car, the user can check individual boxes in the “activate” column 1312. User selection of the “clear” button 1328 will be effective to clear all of the checked boxes in column 1312. Preferably, page 230 also includes a “check all” button (not shown) and an “uncheck all” button (not shown) that are effective, upon user-selection, to respectively check each box or uncheck each box in column 1312 automatically. User selection of the “activate” button 1330 will be effective to flag each vehicle having column 1312 checked for deletion. Once flagged, an appropriate message is preferably communicated to the person in charge of the flagged vehicle (e.g., the branch manager at the branch location where the vehicle is available for rent), thereby allowing the message recipient to promptly pull the vehicle out of the rental fleet and make arrangements for its transfer to the used car market. Alternatively, a database record for an “activated” vehicle can be created that flags that vehicle for deletion. An interested party can thereafter receive a message or report from this database record to become notified of the need to delete the vehicle from the rental fleet and move it to a used car market.

Related tasks button 1334 is preferably selectable by the user to present the user with options to either export the data of screen 230 to Microsoft Excel or to create a printer-friendly version of screen 230 for printing.

It is worth noting that the selection of any of the links 1162 from screen 224 in columns 1170, 1196, or 1198 also navigate the user to an activations page 230. For users who arrive at page 230 from a link in column 1170, the activations tables 1310 will list each fleet vehicle within the YMMS corresponding to the selected link. For users who arrive at page 230 from a link in column 1196, the activations table 1310 will list only the fleet vehicles within the YMMS corresponding to the selected link that are scheduled for deletion. Lastly, for users who arrive at page 230 from a link in column 1198, the activations table 1310 will list only the unactivated fleet vehicles within the YMMS corresponding to the selected link.

While the present invention has been described above in relation to its preferred embodiment, various modifications may be made thereto that still fall within the invention's scope, as would be recognized by those of ordinary skill in the art upon review of the teachings herein. For example, while the preferred embodiment is concerned primarily with rental vehicles, the present invention can also be practiced in connection with calculating normalized historical sales prices and CGFs for leased vehicles. Also, while YMMS serves as convenient criteria for distinguishing between different vehicle types in North America, when dealing with fleets located in countries outside North America, other criteria could be useful. For example, in the United Kingdom, effective criteria would include registration year, registration letter, make, model, spec year, trim, engine size, horsepower, series, gearbox, fuel type, etc. In Ireland, effective criteria would include registration year, spec year, make, model, trim, engine size, horsepower, series, gearbox, fuel type, etc. In Germany, effective criteria would include registration year, spec year, make, model, series, engine size, kilowatts, trim, gearbox, fuel type, etc. As such, the full scope of the present invention is to be defined solely by the appended claims and their legal equivalents.

### APPENDIX A

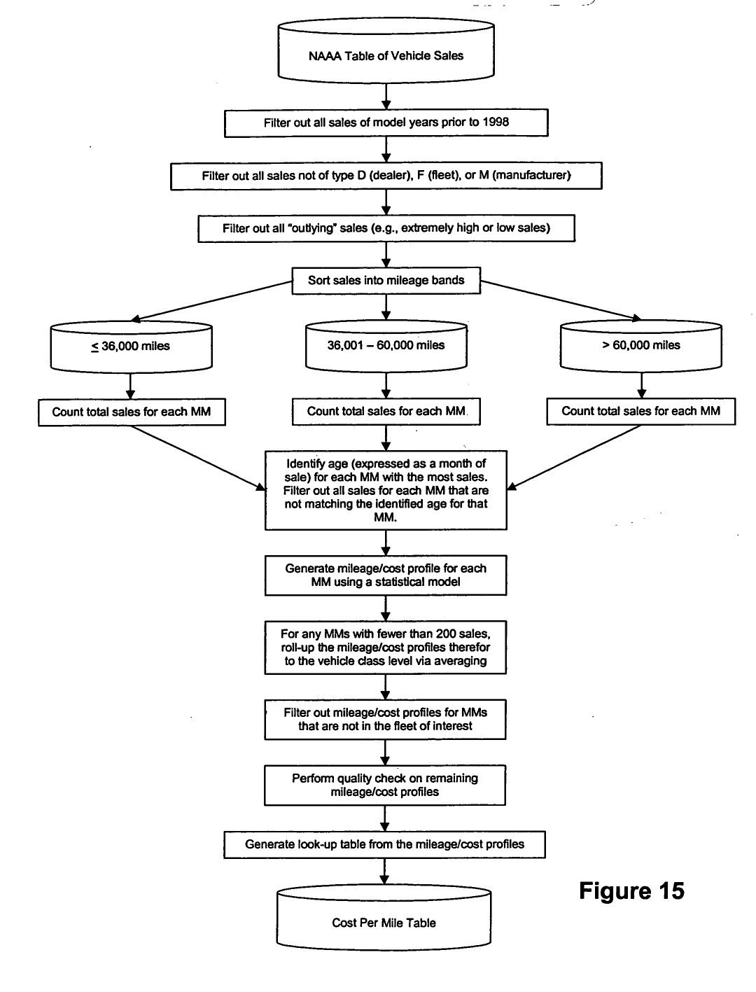

This appendix describes a preferred technique for creating a cost per mile table. FIG. 15 depicts a flowchart for this process. In order to build the tables containing the vehicle values at different mileage bands, the following steps are performed:
1. Pull vehicle sales data from a database of vehicle sales supplied by providers such as NAAA (via NADA) and/or other industry sources.
2. Filter for sales for model years 1998 and later.
3. Filter for sales type of D (dealer), F (fleet) or M (manufacturer).
4. Filter to remove outlying data such as extremely high or low sale prices.
5. Construct three mileage bands:
   1) Less than or equal to 36,000 miles
   2) 36,001-60,000 miles
   3) More than 60,000 miles
Sort sales data into the three mileage bands.
6. Count total sales in each mileage band at the make model (MM) level.
7. Identify the age (expressed as a month) of each MM with the most sales. These months are used in step 8 when generating the mileage profile for the MM.
8. For each MM within each mileage band, and for the determined month's sales, fit a statistical model where sales price is regressed on linear splines of mileage, indicators of the month sold, indicators of model years, and indicators of series to arrive at values for β₀, β₁, β₂, β₃, δₖ, γₖ, and λₖ. β₀ is a general reference level parameter. β₁, β₂, and β₃ are estimated mileage band adjustment parameters. The parameter δₖ is an adjustment parameter estimated from the pertinent sales data to adjust the level of the average sales price for month k (month k being within the sales months applicable to a particular MM). The parameter γₖ is an adjustment parameter estimated from the pertinent sales data to adjust the level of the average sales price for series k (series k being within the various series applicable to a particular MM), and wherein λₖ is an adjustment parameter estimated from the pertinent sales data to adjust the level of the average sales price for model year k (model year k being within the model years applicable to a particular MM). This statistical model is an additive model with no interaction terms. From this fit, a mileage profile is generated where the month is fixed as mentioned in the previous step. Using the values determined for β₀, β₁, β₂, β₃, δₖ, γₖ, and λₖ, a Mean_Sales_Price can be determined for a given mileage for each MM in accordance with the statistical model. A preferred statistical model is as follows for a given MM, wherein parameters β₀, β₁, β₂, β₃, δₖ, γₖ, and λₖ are estimated by minimizing the least squares error, I is the indicator function, the notation (miles—36000)₊ denotes the positive part of the expression inside the parentheses:

$${Mean}_{-} {Sales}_{-} Price = {β}_{0} + {β}_{1} \times miles + {β}_{2} \times {( miles - 36000 )}_{+} + {β}_{3} \times {( miles - 60000 )}_{+} + {\sum }_{{month}_{k}} {δ}_{k} \times {I}_{{month}_{k}} ( month ) + {\sum }_{{series}_{k}} {γ}_{k} \times {I}_{{series}_{k}} ( series ) + {\sum }_{{model}_{\_} {yT}_{k}} {λ}_{k} \times {I}_{{model}_{\_} {yT}_{k}} ( {model}_{\_} yr )$$
See Neter, John and Wasserman, William, Applied Linear Statistical Models, Richard Irwin, Inc., 1974 for a discussion of the statistical techniques used in this step.
9. Identify any MMs with fewer than 200 sales. For such MMs, rollup its sales data to rollup the MM's mileage profile to the vehicle class level by averaging over the profiles of the MMs with sufficient data (more than 200 per mm) sharing that vehicle class.
10. Identify all individual MM in the fleet of interest.
11. Associate the generated mileage profiles for each MM/vehicle class and each mileage band with the MMSs in the current fleet.
12. Perform quality checks on the profiles whose MM matches a MM in the fleet of interest. This quality check includes checking that the mileage profile is montonically decreasing (by identifying positive mileage coefficients) and identifying any unusually steep slopes (by identifying outlying mileage coefficients compared to coefficients associated with similar make models), checking whether the profiles extends across all mileage bands.
13. From these MMs and vehicle classes, generate the look up table for fleet MMSs containing the mileage profiles.
14. If necessary, consult with remarketing personnel for advice on mapping unusual vehicle classes to a vehicle class such that sufficient data is available for the regressions.

What is claimed is:

1. A system for determining a normalized sales price as of a time period for a representative member of a selected vehicle type group, the system including a computer configured to access a database, the database storing historical sales data for members of said group, said historical sales data including actual sales prices, and said computer being further configured to normalize each of said actual sales prices to a representative member of said group and then combine said normalized actual sales prices to determine at least one normalized sales price for said representative member.

2. The system of claim 1 wherein said historical sales data for each member of said group includes an associated time of sale odometer reading, and wherein said representative member is determined by combining the time of sale odometer readings of said members.

3. The system of claim 2 wherein said computer is further configured to normalize said actual sales prices by adjusting each actual sales price corresponding to its associated time of sale odometer reading as compared said representative member.

4. The system of claim 3 wherein the selected vehicle type group is a YMMS.

5. The system of claim 3 wherein said computer is configured to combine said normalized actual sales prices by averaging them.

6. The system of claim 5 wherein said database further includes a cost per time of sale odometer reading table, and wherein said computer is configured to access said cost per time of sale odometer reading table to normalize said actual sales prices.

7. The system of claim 6 wherein said computer is further configured to display said normalized sales price to a user.

8. A method for determining a normalized sales price as of a time period for a representative member of a selected vehicle type group, the method comprising:
accessing stored historical sales data for members of said group, said historical sales data including actual sales prices;
normalizing each of said actual sales prices to a representative member of said group; and
combining said normalized actual sales prices to determine at least one normalized actual sales price for said representative member.

9. The method of claim 8 wherein historical sales data for each member of said group includes an associated time of sale odometer reading, and wherein the method further comprises:
determining said representative member by combining the time of sale odometer readings of said members.

10. The method of claim 9 wherein said normalizing step further comprises normalizing said actual sales prices by adjusting each actual sales price corresponding to its associated time of sale odometer reading as compared to the said representative member.

11. The method of claim 10 wherein the selected vehicle type group is a YMMS.

12. The method of claim 10 wherein the step of combining said normalized actual sales prices comprises combining said normalized actual sales prices by averaging them.

13. The method of claim 12 wherein said normalizing step includes accessing a cost per time of sale odometer reading table to determine an adjustment for use in normalizing said actual sales prices.

14. The method of claim 13 further comprising displaying said normalized sales price to a user.

15. A system for providing a user with historical sales data for a plurality of vehicles comprising a fleet, the system comprising:
a database configured to store actual sales data for a plurality of vehicles that have previously been sold; and
a computer in communication with the database, the computer being configured to create a page for display to a user, the page including a display of a plurality of historical sales prices for at least one vehicle type that is similar to a user-selected vehicle type, wherein the displayed historical sales prices are calculated from the stored actual sales data and comprise historical sales prices for the at least one similar vehicle type that have been normalized to an average time of sale odometer reading.

16. The system of claim 15 wherein the stored actual sales data comprises stored actual sales data for a plurality of fleet vehicles, wherein the stored actual sales data comprises, for each fleet vehicle that has previously been sold, an identification of a vehicle type therefor, a sales price therefor, and an odometer reading therefor at the time of sale, and wherein the computer is further configured to calculate the historical sales prices by:
calculating an average odometer reading at the time of sale for a plurality of the previously sold vehicles of a vehicle type group, the vehicle type group comprising at least one vehicle type that is the same or similar to the user-selected vehicle type;
for each vehicle type of the vehicle type group, (1) normalizing the stored sales prices for a plurality of previously sold vehicles of that vehicle type such that the stored sales prices are normalized to the calculated average odometer reading, and (2) calculating an average normalized sales price from the normalized sales prices.

17. The system of claim 16 wherein the computer is further configured to normalize the stored sales prices using a cost per time of sale odometer reading data table.

18. The system of claim 17 wherein the vehicle types are specified in terms of a year, make, model, and series (YMMS).

19. The system of claim 18 wherein the user-selected vehicle type comprises a current year YMMS, wherein the vehicle type group is a YMMS group, and wherein the YMMS group comprises the current year YMMS and at least one other YMMS similar thereto.

20. The system of claim 19 wherein the stored actual sales data further comprises, for each fleet vehicle that has previously been sold, a month of sale, and wherein the computer is further configured to calculate the historical sales prices on a per month basis such that (1) each calculated average time of sale odometer reading represents the average time of sale odometer reading for a plurality of previously sold vehicles of the YMMS group that were sold in a particular month across a plurality of years of sale and (2) each YMMS's average normalized sales price represents that average normalized sales price for a plurality of previously sold vehicles of that YMMS that were sold in a particular month.

21. The system of claim 20 wherein the computer is further configured to calculate, for a plurality of months, a month-to-month change in the average normalized sales price for each YMMS within the YMMS group.

22. The system of claim 21 wherein the page presents the calculated average normalized sales prices in a table comprising a plurality of rows and a plurality of columns, wherein each column corresponds to a month of the year, wherein at least one row displays the calculated average time of sale odometer reading for each month, and wherein at least one row corresponds to a previous year YMMS within the YMMS group and displays the average normalized sales price for that previous year YMMS for each month.

23. The system of claim 22 wherein at least one additional row of the table corresponds to another previous year YMMS within the YMMS group and displays the average normalized sales price for the another previous year YMMS for each month.

24. The system of claim 23 wherein the rows are arranged chronologically by the year corresponding to each row's YMMS.

25. The system of claim 22 wherein the table further comprises a row for each YMMS within the YMMS group, these plurality of rows displaying the calculated month-to-month average normalized sales price changes.

26. The system of claim 25 wherein the computer is further configured to calculate, for a plurality of months, a year-to-year change in a given month's average normalized sales price for a particular YMMS within the YMMS group relative to that given month's average normalized sales price for a YMMS of the year previous to that particular YMMS.

27. The system of claim 26 wherein the table further comprises another row for each YMMS within the YMMS group, these plurality of another rows displaying the calculated year-to-year average normalized sales price changes.

28. The system of claim 24 wherein the table further includes, in a row corresponding to the user-selected YMMS, at least one field for user entry of a residual value estimate for the user-selected YMMS, wherein the residual value estimate is applicable to a current or future month.

29. The system of claim 28 wherein the page further includes a link selectable by the user for to display another page, the another page presenting a cost going forward (CGF) analysis to the user that is applicable to the user-selected YMMS, the CGF analysis being based at least in part upon the at least one user-entered residual value estimate.

30. The system of claim 29 wherein the CGF analysis is further based at least in part upon a user-specified projection period.

31. The system of claim 19 wherein the computer is further configured to limit which previously sold fleet vehicles are considered in the historical sales price calculations on the basis of at least one user-specified criteria.

32. The system of claim 31 wherein the at least one user-specified criteria comprises a geographical constraint.

33. The system of claim 15 wherein the computer is accessible to a plurality user computers via an intranet.

34. The system of claim 15 wherein the computer is accessible to a plurality user computers via the Internet.

35. An apparatus for providing a user with historical sales data for a plurality of vehicles comprising a fleet, the apparatus comprising:
a computer in communication with a database, the database being configured to store actual sales data for a plurality of vehicles that have previously been sold, wherein the computer is configured to create a page for display to a user, the page including a display of a plurality of historical sales prices for at least one vehicle type that is similar to a user-selected vehicle type, wherein the displayed historical sales prices are calculated from the stored actual sales data and comprise historical sales prices for the at least one similar vehicle type that have been normalized to an average time of sale odometer reading.

36. The apparatus of claim 35 wherein the stored actual sales data comprises stored actual sales data for a plurality of fleet vehicles, wherein the stored actual sales data comprises, for each fleet vehicle that has previously been sold, an identification of a vehicle type therefor, a sales price therefor, and an odometer reading therefor at the time of sale, and wherein the computer is further configured to calculate the historical sales prices by:
calculating an average odometer reading at the time of sale for a plurality of the previously sold vehicles of a vehicle type group, the vehicle type group comprising at least one vehicle type that is the same or similar to the user-selected vehicle type;
for each vehicle type of the vehicle type group, (1) normalizing the stored sales prices for a plurality of previously sold vehicles of that vehicle type such that the stored sales prices are normalized to the calculated average odometer reading, and (2) calculating an average normalized sales price from the normalized sales prices.

37. The apparatus of claim 36 wherein the computer is further configured to normalize the stored sales prices using a cost per time of sale odometer reading data table.

38. The apparatus of claim 37 wherein the vehicle types are specified in terms of a year, make, model, and series (YMMS).

39. The apparatus of claim 38 wherein the user-selected vehicle type comprises a current year YMMS, wherein the vehicle type group is a YMMS group, and wherein the YMMS group comprises the current year YMMS and at least one other YMMS similar thereto.

40. The apparatus of claim 39 wherein the stored actual sales data further comprises, for each fleet vehicle that has previously been sold, a month of sale, and wherein the computer is further configured to calculate the historical sales prices on a per month basis such that (1) each calculated average time of sale odometer reading represents the average time of sale odometer reading for a plurality of previously sold vehicles of the YMMS group that were sold in a particular month across a plurality of years of sale and (2) each YMMS's average normalized sales price represents that average normalized sales price for a plurality of previously sold vehicles of that YMMS that were sold in a particular month.

41. The apparatus of claim 40 wherein the computer is further configured to calculate, for a plurality of months, a month-to-month change in the average normalized sales price for each YMMS within the YMMS group.

42. The apparatus of claim 41 wherein the page presents the calculated average normalized sales prices in a table comprising a plurality of rows and a plurality of columns, wherein each column corresponds to a month of the year, wherein at least one row displays the calculated average time of sale odometer reading for each month, and wherein at least one row corresponds to a previous year YMMS within the YMMS group and displays the average normalized sales price for that previous year YMMS for each month.

43. The apparatus of claim 42 wherein at least one additional row of the table corresponds to another previous year YMMS within the YMMS group and displays the average normalized sales price for the another previous year YMMS for each month.

44. The apparatus of claim 43 wherein the rows are arranged chronologically by the year corresponding to each row's YMMS.

45. The apparatus of claim 42 wherein the table further comprises a row for each YMMS within the YMMS group, these plurality of rows displaying the calculated month-to-month average normalized sales price changes.

46. The apparatus of claim 45 wherein the computer is further configured to calculate, for a plurality of months, a year-to-year change in a given month's average normalized sales price for a particular YMMS within the YMMS group relative to that given month's average normalized sales price for a YMMS of the year previous to that particular YMMS.

47. The apparatus of claim 46 wherein the table further comprises another row for each YMMS within the YMMS group, these plurality of another rows displaying the calculated year-to-year average normalized sales price changes.

48. The apparatus of claim 44 wherein the table further includes, in a row corresponding to the user-selected YMMS, at least one field for user entry of a residual value estimate for the user-selected YMMS, wherein the residual value estimate is applicable to a current or future month.

49. The apparatus of claim 48 wherein the page further includes a link selectable by the user for to display another page, the another page presenting a cost going forward (CGF) analysis to the user that is applicable to the user-selected YMMS, the CGF analysis being based at least in part upon the at least one user-entered residual value estimate.

50. The apparatus of claim 49 wherein the CGF analysis is further based at least in part upon a user-specified projection period.

51. The apparatus of claim 39 wherein the computer is further configured to limit which previously sold fleet vehicles are considered in the historical sales price calculations on the basis of at least one user-specified criteria.

52. The apparatus of claim 51 wherein the at least one user-specified criteria comprises a geographical constraint.

53. The apparatus of claim 35 wherein the computer is accessible to a plurality user computers via an intranet.

54. The apparatus of claim 35 wherein the computer is accessible to a plurality user computers via the Internet.

55. A method for a providing a user with historical sales data related to a plurality of vehicles comprising a fleet, the method comprising:
receiving input from the user indicative of a vehicle type;
for each of a plurality of previously sold vehicles corresponding to the selected vehicle type, determining an actual sales price and an actual time of sale odometer reading therefor;
determining an average time of sale odometer reading from at least a plurality of the determined actual time of sale odometer readings;
normalizing at least a plurality of the determined actual sales prices to the determined average time of sale odometer reading;
averaging the normalized sales prices together; and
displaying the average of the normalized sales prices to the user.

56. The method of claim 55 wherein the previously sold vehicles comprise previously sold fleet vehicles, wherein the selected vehicle type has an associated vehicle type group, the vehicle type group comprising the selected vehicle type and at least one other vehicle type, and wherein:
the actual sales price and actual time of sale odometer reading determining step comprises, for each of a plurality of previously sold fleet vehicles corresponding to the vehicle type group associated with the selected vehicle type, determining an actual sales price and an actual time of sale odometer reading therefor;
the averaging step comprises categorizing the actual sales prices by vehicle type and averaging together the normalized sales prices that are commonly categorized to thereby create a plurality of average normalized sales prices, each average normalized sales price corresponding to a different vehicle type; and
the displaying step comprises displaying the averages of the normalized sales prices to the user.

57. The method of claim 56 wherein the user-selected vehicle type is a year, make, model, and series (YMMS).

58. The method of claim 57 wherein the normalizing step normalizes the actual sales prices to the determined average time of sale odometer reading using a cost per odometer reading data table.

59. The method of claim 58 wherein the cost per odometer reading data table relates a plurality of odometer readings for a vehicle type to a plurality of estimated values determined at least partially on the basis of a statistical model, wherein the average time of sale odometer reading step is performed on a per month basis across a plurality of years, and wherein the normalizing step and the averaging step are performed on a per month per year basis.

60. The method of claim 55 wherein the fleet comprises a plurality of rental vehicles.

61. The method of claim 55 wherein the fleet comprises a plurality of leased vehicles.

62. A computer-implemented method for selecting which of a plurality of vehicles within a fleet are to be deleted from the fleet; the method comprising:
displaying, on an electronic page presented to a computer user, a value analysis for at least one type of vehicle within a vehicle fleet;
providing at least one link on the electronic page for selection by the user to initiate a deletion from the fleet of at least one fleet vehicle corresponding to the at least one vehicle type; and
responsive to user selection of the at least one link, displaying a list of fleet vehicles for selectable deletion from the fleet by the user, the listed fleet vehicles corresponding to vehicles of the at least one vehicle type.

63. The method of claim 62 wherein the vehicle fleet is a rental vehicle fleet, wherein the value analysis is a cost going forward (CGF) analysis, and wherein the vehicle type is a year, make, model, and series (YMMS).

64. The method of claim 63 wherein the displaying step comprises displaying, on the electronic page, a cost going forward (CGF) analysis for each YMMS within the fleet corresponding to a user-selected vehicle class.

65. The method of claim 64 wherein the displaying step further comprises displaying a count of vehicles within the fleet for each YMMS corresponding to the user-selected vehicle class.

66. The method of claim 65 wherein the providing step comprises providing a plurality of links, each link being associated with a different one of the YMMSs corresponding to the user-selected vehicle class and being selectable by the user to initiate a deletion of at least one vehicle from the fleet that corresponds to the link's associated YMMS.

67. The method of claim 66 wherein the step of displaying a list of vehicles for selectable deletion from the fleet by the user comprises displaying a list of fleet vehicles within the YMMS corresponding to the selected link for selectable deletion by the user.

68. The method of claim 62 further comprising:
responsive to user selection of at least one vehicle from the list, sending an electronic message to a person having managerial control over that vehicle, wherein the message informs that person that that vehicle is to be deleted from the fleet.

69. The method of claim 62 further comprising:
responsive to user selection of at least one vehicle from the list, creating a flag in a fleet database that that vehicle is to be deleted from the fleet.

70. The method of claim 62 wherein the fleet comprises a plurality of rental vehicles.

71. The method of claim 62 wherein the fleet comprises a plurality of leased vehicles.

72. A method for creating a group of similar vehicle types to facilitate a historical sales price analysis of similar vehicles within a fleet of vehicles, the method comprising:
receiving an identification from user of at least one vehicle type;
receiving input from the user that indicates each identified vehicle type is deemed by the user to be similar to another vehicle type; and
responsive to the received user input, creating a vehicle type group comprising each identified vehicle type and the another vehicle type, the created group for use in performing a historical sales analysis of vehicle types that are similar to a user-selected vehicle type.

73. The method of claim 72 wherein the vehicle type is year, make, model, and series (YMMS).

74. The method of claim 73 wherein the identification receiving step further comprises receiving identifications of a plurality of YMMSs.

75. The method of claim 74 wherein the another vehicle type is a user-selected YMMS.

76. The method of claim 75 wherein at least two of the identified YMMSs are YMMSs of the same year.

77. A system for providing a user with data about a fleet comprising a plurality of vehicles, the apparatus comprising:
a database configured to store data relating to a plurality of vehicles comprising a fleet, the stored data including an identification of a vehicle classification for each fleet vehicle, the database being updated with vehicle data on a periodic basis, the periodic basis being either a regular periodic basis or an irregular periodic basis;
a computer in communication with the database, the computer being configured to:
process the stored data to (1) determine a total number of vehicles within the fleet, (2) determine a total count of fleet vehicles for each of a plurality of vehicle classifications, and (3) determine a mix percentage for each vehicle classification from the determined total number and the determined total counts, each mix percentage representing how much of the total fleet count is made up of fleet vehicles of a given vehicle class; and
create a page for display to a user that displays the determined total counts and the determined mix percentages together with their corresponding vehicle classes, the displayed counts and mix percentages being current as to the last time the database was updated each time that the page is created and displayed.

78. The system of claim 77 wherein the page includes a table, the table identifying the plurality of vehicle classes and identifying the determined total counts and the determined mix percentages for each vehicle class.

79. The system of claim 78 wherein the fleet comprises a plurality of rental vehicles.

80. The system of claim 78 wherein the fleet comprises a plurality of leased vehicles.
